(19) United States
(12) Patent Application Publication
(10) Pub. No.: US 2018/0254898 A1
(43) Pub. Date: Sep. 6, 2018

(54) DEVICE ENROLLMENT PROTOCOL

(71) Applicant: Rivetz Corp., Wilmington, DE (US)

(72) Inventors: Steven Sprague, Richmond, MA (US); Michael Sprague, New York, NY (US)

(21) Appl. No.: 15/910,763

(22) Filed: Mar. 2, 2018

Related U.S. Application Data
(60) Provisional application No. 62/467,678, filed on Mar. 6, 2017.

(51) Int. Cl. H04L 9/08; H04L 9/06; H04L 9/00; H04L 9/32; H04L 9/14; H04L 9/30

(52) U.S. Cl. CPC H04L 9/0866; H04L 9/0637; H04L 9/006; H04L 9/30; H04L 9/14; H04L 9/3242; H04L 9/3271

(57) ABSTRACT

A device enrollment method and system comprising trusted application code that is executed in isolation from the primary OS of a hosting device and an access control mechanism that manages access to this code. The trusted application code provides hardware-backed cryptographic and authentication services to multiple third party applications. The value of these services is dependent on the integrity of both the trusted application and the third party service applications that access the trusted application. To assert trust, the trusted application may be installed in the device's TEE per existing industry TEE provisioning mechanisms. The process may involve the generation of a unique device key within the trusted application that is signed by a provisioning agent. Through this device key, the access control mechanism obtains cryptographic assurance of the integrity of the trusted application when controlling access to the host device in transactions with online service providers.

### RELATED APPLICATIONS

This application claims the benefit of U.S. Provisional Application No. 62/467,678 filed on Mar. 6, 2017. This application is related to U.S. application Ser. No. 15/074,784, filed Mar. 18, 2016, which claims the benefit of U.S. Provisional Application No. 62/136,340 filed on Mar. 20, 2015 and U.S. Provisional Application No. 62/136,385 filed on Mar. 20, 2015. The entire teachings of the above applications are incorporated herein by reference.

### BACKGROUND

The advent of decentralized transaction systems (such as Bitcoin) has provided the Internet with a reliably secure protocol for recording ownership over digital value, known as the block chain. The system is rooted in cryptographic keys that enable people to exercise that digital value. However, when these keys are stored digitally, and particularly when they are transacted, they are vulnerable to theft which can result in substantial losses. Industry has for years anticipated a need for high-assurance operations in endpoint devices. Already deployed hardware security can be used to enhance the security and privacy on endpoint devices for interactions between people and the block chain.

The block chain behind Bitcoin, the common ledger that is built on the backs of thousands of peered servers, is devised to be mathematically impenetrable. As long as a majority of participating peers act in support of the community, one cannot leverage enough compute power to edit records of the past and thus steal value. With such a large community maintaining the integrity of the block chain, only vulnerability in elliptic curve cryptography could compromise the block chain. However, while the block chain itself is well secured, the manner that an individual must transact with the block chain is either very complex or subject to a number of well-known malware attacks. The result is that the quality of the instructions to the block chain is critical to assuring the quality of the protected transaction ledger.

### SUMMARY

Most of the transactions captured in the block chain (e.g., Bitcoin block chain) record a transfer of value from one person to another. Cryptographic public keys represent the participants involved in the transfer and corresponding cryptographic private keys are applied to sign a transfer request and enable a participant to claim the transfer result in the block chain. As there is no other method of oversight or control in the block chain, it is paramount that the keys (particularly the private keys) be secured for use in transfers of value. Further, the block chain is an ephemeral construct, and a person can only interact with the block chain to record a transfer through the person's control of a network connected device. Broadly speaking there are three ways in which the block chain transfer request or instruction can take place. First, a person (user) controls the device (machine), which is itself a peer of the block chain and writes directly into the block chain. Second, the person (user), via the device, accesses a web site or mobile app to instruct a server acting on the person's behalf to write to the block chain. Third, the person (user), via a device, accesses a web site or app to propagate to the block chain a transaction that is locally formed on the device.

To secure the cryptographic keys and associated transactions, embodiments of the present invention leverage device identity. In embodiments, an important step in leveraging device identity is device enrollment. In an example embodiment, device enrollment may be enacted under the oversight of some trusted entity. For example, enrollment of a phone could take place at the point of sale, where binding between the end user and the device identity can be established by physical presence of the device user. However, in many cases this level of person-to-device association is neither necessary nor desired. For example, attributes that could be considered personally identifying information (PII) should not be inextricably linked to the device identity. Rather, basic device identity should be purely anonymous. To reliably enroll a device, two criteria are required: (1) the ability to generate a digital cryptographic key pair (with a public and private portion) that is locked to the device, and (2) assurance of the provenance and quality of the generated key pair. The latter may be provided either by social engineering, supply chain cryptography, or such. For example, a device identity registered in the presence of a respected purveyor is likely to be a real device, as the purveyor would likely want to preserve the purveyor's reputation. Similarly, trust in a device that is keyed on a manufacturing floor and can be confirmed with an OEM certificate authority that is built on the reputation of that manufacturer.

In some embodiments, enrollment involves establishing uniqueness associated to the device, which can be queried but not spoofed. For this, a trusted execution environment (or similar hardware root of trust) installed on the device may be used. A trusted application executing in the trusted execution environment (e.g., Trusted Platform Module (TPM) chip) may generate the digital cryptographic key pair on the device, and sends the public portion of the key pair to a device client, which in turn posts it to an authentication (access control) website or application. The authentication application may generate a random identifier for the device and then generate a device record containing the random identifier and public key, which is recorded in a block chain (e.g., Namecoin or similar block chain, or block chain method, devised to record named data). Once recorded in the block chain, the device record can be extended and modified with attributes, such as platform configuration register (PCR) quotes, associated service provider (e.g., Bitcoin) accounts, or any other data related to authentication of the device identity.

In some embodiments, large device records are referenced with a hash and Uniform Resource Locator (URL) in the block chain, rather than directly recorded. The authentication application (or other enrollment agent), in conjunction with the user device, controls the block chain account that can access and update this device record. Other embodiments include self-enrolled devices, where the authentication application is replaced or executed by a trusted application on the device. Once enrolled, a service provider can access the public keys of the device (via the authentication application) to validate, encrypt, and sign communications with cryptographic assurance that the associated communication attributes emanated from the device.

In some embodiments, in the trusted execution environment (TEE) of the device, the features of device identity are provided, while further extending the ability to execute code in isolation from the rest of the system. Example embodiments provide a service component or application (e.g., Bitcoin service component) that is packaged for deployment by a service provider in a variety of TEE environments, such as configured on the user device. The service component or application deployed in the TEE provides critical enhancements to the execution of a transaction, for example: (1) the service provider application (code) executed in the TEE may be signed and authenticated by a third-party trusted application manager (TAM), thereby preventing the code from being tamper; (2) the service provider application executed in the TEE is executed outside the host operating environment and, thus, is protected from malware; and (3) data from the executed service provider application, including the generated key pair, are never exposed outside of the TEE.

An enrolled device can build up a record of attributes that enable service providers to verify the current state and context of the enrolled device. Device attributes need not include any PII to be useful for verification. For example, a recent statement from the device declaring a clean boot sequence can give a service provider some confidence that the machine is not compromised. Attributes that provide singular assertion of a fact, without divulging much PII, can also be useful, such as the device operator being validated as over 21, or as a French citizen or member of an affinity club. A service provider (or authentication application/website) may interact with the enrolled device to collect a statement of the device's boot integrity (e.g., quotes from platform configuration registers (PCRs)). The device's boot integrity may be formatted as collection of hashes that can be compared against the last boot statement saved for the device. A device that booted in a predictable way is believably more reliable than has a changed BIOS or OS. In addition to PCR quotes, participating anti-virus software can deliver a statement that the machine was cleared as of the last virus scan.

The execution environment of the enrolled device is responsible for determining the accuracy of a transfer request and protecting the device key (in particularly the private portion). The Internet is largely accessed by multi-purpose devices, such as PCs, tablets, and phones, that may host hundreds of applications (apps) in the device's execution environment, and the vibrant market for new applications drive a very open environment. The hosting of the service provider applications (apps) on the device is user friendly until one of the hosted apps disguises a malicious intent and begins to vandalize or steal from the other apps hosted on the user device. To prevent such vandalism and theft, a service provider associated with a hosted application should not only check if the correct device is executing the service, but request if the device is in the same health and integrity state as when the hosted application was installed on the device (e.g., BIOS not changed). When significant changes in the device state have occurred, the change can indicate a potential threat to the service provider. Knowable of this changed state (potential threat) enables the service provider to take remedial actions, or at least request further confirmation from the device or device operator that the device is indeed safe for providing the service. Such check of device state may be performed by an authentication application or website communicatively coupled to the device and the service provider.

In some embodiments, integration of the principles of Trusted Network Connect (TNC) would allow a full validation of a device prior to a service provider accepting a transaction with the device. The device being in a known good condition or state prior to the acceptance of a transaction is based on statement by the authentication application (or other third-party application) that the device is configured correctly. This type of validation addresses a broad range of cyber security controls that may be preferably required as part of any transaction processing.

Embodiments of the present invention are directed to computer methods, systems, and program products for controlling access between a computing device with a service provider. The computer program products comprise a non-transitory computer-readable storage medium having code instructions stored thereon, the storage medium operatively coupled to a processor to execute the computer method embodiments. The systems may include a trusted application executing in an environment on a computing device and an access control application executing in an environment on or communicatively coupled to the computing device facilitating access control to the computing device. The access control application may also be communicatively coupled to an access control server, authentication website, and service provider. The system may also include a service provider application executing in an environment on or communicatively coupled to the computing device to execute instructions related to a service provider. The service provider may include a service provider server executing an encoder, the service provider server also communicatively coupled to the access control server.

The methods and systems execute the trusted application in an environment on a computing device in isolation from the primary operating system (OS) of the computing device. The methods and systems (via the trusted application) generate a unique device key (or multiple device keys in some embodiments) for the computing device within the executed trusted application and register the generated unique device key for the computing device with an access control service. The methods and systems (via the access control application) pair the computing device with a service provider registered with the access control service. The pairing includes the access control application sending: (i) the unique device key to the service provider and (ii) a unique service key of the service provider to the computing device.

In some embodiments, the methods and systems then proceed to perform a service transaction (e.g., transfer for value). The methods and systems (via the encoder) sign an instruction using the unique service key, and send the signed instruction to the computing device. In some embodiments, the methods and systems (via the encoder) also encrypt the instruction using the unique device key prior to sending the instruction. The methods and systems (e.g., via the trusted application) verify the signature of the instruction matches the unique service key. In embodiments where the instruction is encrypted, the methods and systems (e.g., via the trusted application) also decrypt the signed instruction using the unique device key prior to executing the instruction within the trusted application.

If the instruction signature is verified, the methods and systems (e.g., via the trusted application in communication with the service provider application) execute the instruction within the trusted environment of the computing device to generate instruction results, and record the executed instruction on the block chain. The methods and systems (e.g., via the trusted application) sign the instruction results using the unique device key, and send the signed instruction results to the service provider. The methods and systems (e.g., via the encoder) verify the signature of the instruction results matches the unique device key. If instruction results signature is verified, the methods and systems (e.g., via the encoder) record the instruction results on the block chain.

In some embodiments, the methods and systems (e.g., via the trusted application in communication with the service provider application) accumulate in memory local to the computing device instructions received at the computing device from the service provider. The methods and systems (e.g., via the trusted application) record the accumulated instructions (or a right granted based on the accumulated instructions) on the block chain once the accumulated instructions meet a threshold condition record.

In some embodiments, the methods and systems (e.g., via the access control application) maintain an access control list for the pairing that includes at least one of: the unique device key, the unique service key, an effective date when the instruction is allowed to be executed by the trusted application, an expiration date when the instruction is no longer allowed to be executed by the trusted application, whether the instruction is within a limit on a set number of executions, and whether the instruction is within an external condition requiring positive verification prior to execution of the instruction. In example embodiments, the methods and systems (e.g., via the trusted application in communication with the access control application) verify the instruction against the access control list prior to executing the instruction. In some of these example embodiments, the methods and systems (e.g., via the trusted application in communication with the access control application) assure completion of verification against the access control list by an access control system using a PKI challenge response. In some embodiments, the methods and systems (e.g., via the trusted application in communication with the access control application) provide evidentiary proof of state of the access control list by associating an external time stamp or an external block chain registration event with the access control list. In some embodiments, the methods and system (e.g., via the access control application) backup at least a portion of the access control list in a manner such that the backed-up access control list is recoverable. Certain secure elements of the access control list may be excluded from the backed-up access control list. In some embodiments, the methods and systems (e.g., via the access control application) maintain one or more logs associated with the access control list containing at least one of: number of times a given instruction is executed and specific functions of the given instruction.

In some embodiments, the methods and systems (e.g., via the trusted application or third party service communicatively coupled to the computing device) measure current health and integrity of the computing device. The methods and systems (e.g., via the trusted application or third party service communicatively coupled to the computing device) further verify the current measured health and integrity against a stored reference value of the measured health and integrity of the computing device in a known good state. The methods and systems (e.g., via the encoder) then send the signed instruction to the computing device, only if the current measured health and integrity of the computing device is verified. In example embodiments, the methods and systems (e.g., via the trusted application or third party service communicatively coupled to the computing device) measure and store the reference value when the computing device powers on and when a change is detected in an environment of the computing device. In example embodiments, the measured health and integrity includes one or more of: platform configuration registers (PCRs) generated by the boot process, BIOS Version, OS Version, GPS location, manufacturing company name, device make, and device model. In some embodiments, the methods and systems (e.g., via the trusted application or access control application) integrate the current state of an access control list into the device health and integrity measurement, and exclude dynamic data capable of modifying the device health and integrity measurement from the health and integrity measurement. In example embodiments, the methods and systems at least one of: (i) sign (via the encoder) the instruction by both the unique device key and a hash of the current measured health and integrity and (ii) sign (via the trusted application) the instruction results by both the unique service provider key and a hash of the current measured health and integrity.

In some embodiments, the methods and systems require a new application installed on the computing device to register with the trusted application prior to the trusted application allowing an instruction to be executed by the new application. In example embodiments, the methods and systems revoke the trusted application from the user device by either setting a revocation flag or removing the trusted application. In some embodiments, the methods and system (e.g., via a ring manager) group multiple computer devices operated by the user of the computing device into a single entity and generate one unique device key for the group. In example embodiments, the unique device key and the unique service key are each a public key of a digital cryptographic public and private key pair. In example embodiments, the methods and systems (e.g., via the trusted application) register an operator of the computing device within the trusted application (e.g., associated with a username, password, PIN, biometrics, and such).

Embodiments of the present invention are directed to computer methods, systems, and program products for determining digital ownership rights. The computer program products comprise a non-transitory computer-readable storage medium having code instructions stored thereon, the storage medium operatively coupled to a processor to execute the computer method embodiments. The systems include an account associated with an application configured on a block chain communication network. The account including a wallet coupled to an address on the block chain communication network. The systems also include a transaction record associated with the blockchain account and communicatively coupled to the block chain application. In some embodiments, the block chain application and transaction record are included in a smart contract. The systems further include a service provider application communicatively coupled to the block chain application over the block chain communication network.

The methods and systems send (e.g., via the service provider application) to a block chain account a series of transactions related to one or more specific items provided by a service provider. The methods and systems receive (e.g., via the block chain application) a current transaction of the series of transactions and recording the current transaction in a transaction record coupled to the block chain account. The methods and systems (e.g., via the block chain application) check the transaction record for a previous transaction associated with the block chain account and service provider.

If a previous transaction exists, the methods and systems (e.g., via the block chain application) proceed as follows. The methods and systems obtain an accumulation attribute attached to the previous transaction, the accumulation attribute indicating an accumulation of transactions of the one or more specific items. In some embodiments, the accumulation attribute is one of: an accumulated value or a count of transactions. The methods and systems increment the accumulation attribute based on a specific item of the current transaction. If the incremented accumulation attribute meets a defined threshold, the methods and systems determine an ownership right related to the series of transaction and record the ownership right in the block chain communication network associated to the block chain wallet address. Otherwise, the methods and systems attaching the incremented accumulation attribute to the recorded current transaction in the transaction record.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1A is an example digital processing environment in which embodiments of the present invention may be implemented.

FIG. 1B is a block diagram of any internal structure of a computer/computing node.

FIG. 2A is a block diagram showing an example device authentication system in an embodiment of the present invention.

FIG. 2B is a diagram showing an example set of components of a device authentication system according in an embodiment of the present invention.

FIG. 2C is a diagram of another example set of components in an embodiment of the present invention.

FIG. 2D is a diagram of an adaptor component of a device authentication system in an embodiment of the present invention.

FIG. 3A is a diagram of an example protocol for enrolling a device in an embodiment of the present invention.

FIG. 3B is a diagram of an example protocol for pairing a device in an embodiment of the present invention.

FIG. 3C is a diagram of an example protocol for processing an transaction instruction in embodiments of the present invention.

FIG. 4 is a flow chart of an example method of access control for a device in embodiments of the present invention.

### DETAILED DESCRIPTION OF THE INVENTION

A description of example embodiments of the invention follows.

Some elements described herein may be further described in U.S. patent application Ser. No. 15/074,784, filed Mar. 18, 2016, U.S. Provisional Application No. 62/136,340, filed on Mar. 20, 2015, U.S. Provisional Application No. 62/136,385, filed on Mar. 20, 2015, U.S. Pat. No. 6,092,202, issued on Jul. 18, 2000, and U.S. Pat. No. 6,138,239, issued on Oct. 24, 2000, which are herein incorporated by reference in their entirety.

### Digital Processing Environment

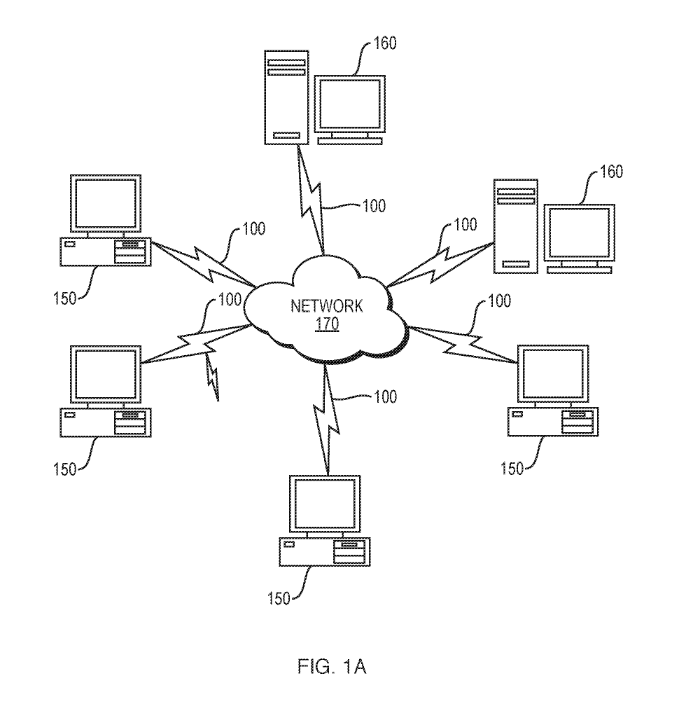

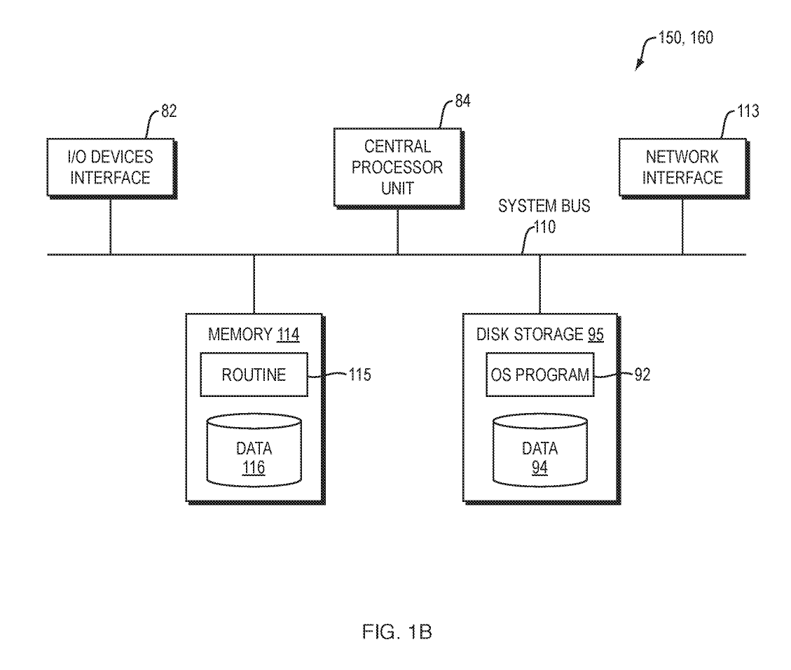

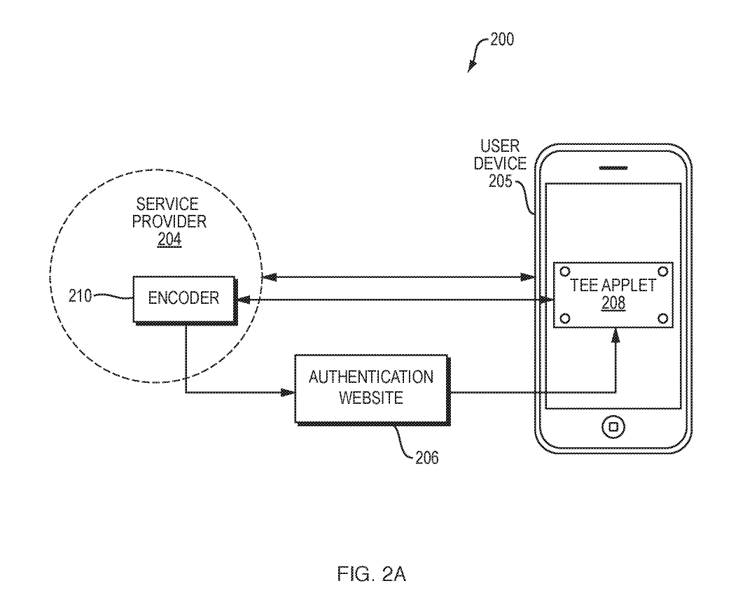

An example implementation of a device authentication system 100 according to an embodiment of the invention for enrolling a device to perform service transactions may be implemented in a software, firmware, or hardware environment. FIG. 1A illustrates one such example digital processing environment in which embodiments of the present invention may be implemented. Client computers/devices 150 and server computers/devices 160 provide processing, storage, and input/output devices executing application programs and the like.

Client computers/devices 150 may be linked directly or through communications network 170 to other computing devices, including other client computers/devices 150 and server computer/devices 160. The communication network 170 can be part of a wireless or wired network, remote access network, a global network (i.e. Internet), a worldwide collection of computers, local area or wide area networks, and gateways, routers, and switches that currently use a variety of protocols (e.g. TCP/IP, Bluetooth®, RTM, etc.) to communicate with one another. The communication network 170 may also be a virtual private network (VPN) or an out-of-band network or both. The communication network 170 may take a variety of forms, including, but not limited to, a data network, voice network (e.g. land-line, mobile, etc.), audio network, video network, satellite network, radio network, and pager network. Other electronic device/computer networks architectures are also suitable.

Server computers 160 of the device authentication system 100 may be configured to provide an access control server executing an authentication application or website which communicates with computing devices and server provider platforms. The server computers 160 may register a computing device using an established identity (e.g., cryptographic public key of a public/private key pair) of the device, and register a service provider using an established identity (e.g., cryptographic public key of a public/private key pair) of the service provider. The server computers 160 may also pair the device and service provider using the established identities, including providing the service provider identity (public key) to the device and providing the device identity to the service provider. The server computers 160 may also monitor access control behavior within the pairing based on an access control list or a measured reference value indicating a known good condition or state of the device. The server computers 160 may also record the registration, pairing, access control list, and measured reference value in a block chain or other secure global memory. The server computers may not be separate server computers but part of cloud network.

Client computers 150 of the device authentication system 100 may be computing devices configured with a trusted execution environment (TEE) and trusted application to generate the established identity (public/private key pair) of the device. The Client computers 150 may also compute signatures, encrypt/decrypt, and execute instructions and instruction results as part of a transaction with a service provider.

FIG. 1B is a block diagram of any internal structure of a computer/computing node (e.g., client processor/device 150 or server computers 160) in the processing environment of FIG. 1A, which may be used to facilitate displaying audio, image, video or data signal information. Each computer 150, 160 in FIG. 1B contains a system bus 110, where a bus is a set of actual or virtual hardware lines used for data transfer among the components of a computer or processing system. The system bus 110 is essentially a shared conduit that connects different elements of a computer system (e.g., processor, disk storage, memory, input/output ports, etc.) that enables the transfer of data between elements.

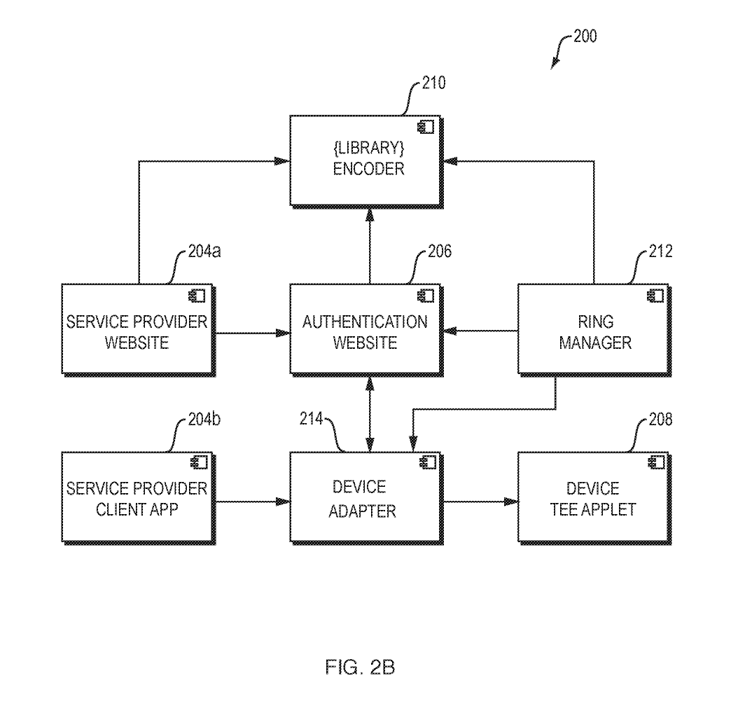

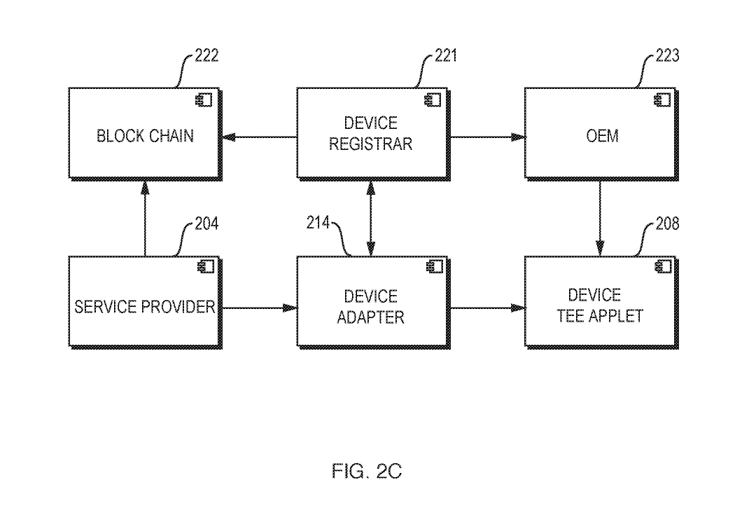

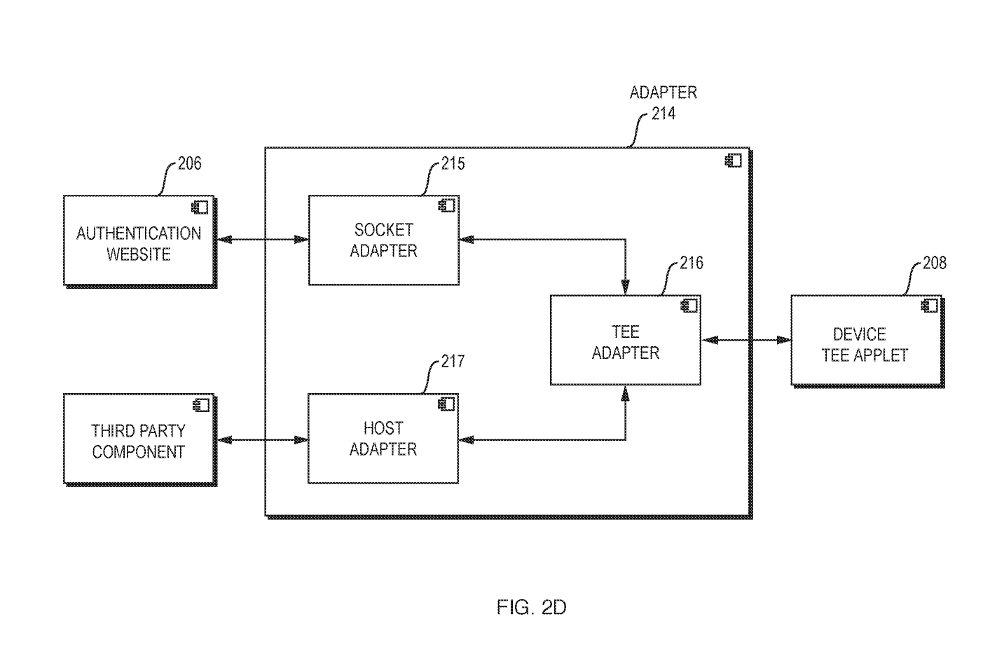

Attached to the system bus 110 is an I/O device interface 82 for connecting various input and output devices (e.g., keyboard, mouse, touch screen interface, displays, printers, speakers, audio inputs and outputs, video inputs and outputs, microphone jacks, etc.) to the computer 150, 160. A network interface 113 allows the computer to connect to various other devices attached to a network (for example the network illustrated at 170 of FIG. 1A). Memory 114 provides volatile storage for computer software instructions 115 and data 116 used to implement software implementations of authentication components of some embodiments of the present invention (as shown in FIGS. 2A-2D). Such device authentication software components 115, 116 of the user authentication system 100 (e.g. encoder 210, Trusted Execution Environment (TEE) applet 208, and authentication website 206 of FIG. 2A) described herein may be configured using any programming language, including any high-level, object-oriented programming language, such as Python.

In an example mobile implementation, a mobile agent implementation of the invention may be provided. A client server environment can be used to enable mobile security services using the server 160. It can use, for example, the XMPP protocol to tether a device authentication engine/agent 115 on the device 150 to a server 160. The server 160 can then issue commands to the mobile phone on request. The mobile user interface framework to access certain components of the system 100 may be based on XHP, Javelin and WURFL. In another example mobile implementation for OS X and iOS operating systems and their respective APIs, Cocoa and Cocoa Touch may be used to implement the client side components 115 using Objective-C or any other high-level programming language that adds Smalltalk-style messaging to the C programming language.

The system 100 may also include instances of server processes on the server computers 160 that may comprise an authentication application, service provider application, or TEE applet 208 (FIG. 2A), which allow generating keys for a device, registering a device, pairing a device to a service provider, verifying an instruction of a service transaction against an access control list or reference value of health and integrity of the device, signing the instruction, encrypting/decrypting the instructions, and executing the instruction.

Disk storage 95 provides non-volatile storage for computer software instructions 92 (equivalently “OS program”) and data 94 used to implement embodiments of the system 100. The system may include disk storage accessible to the server computer 160. The server computer can maintain secure access to records in the block chain related to the device, service provider, pairing of the device and service provider, and access control at the device. Central processor unit 84 is also attached to the system bus 110 and provides for the execution of computer instructions at the device (e.g., in the TEE of the device).

In an example embodiment, the processor routines 92 and data 94 are computer program products. For example, if aspects of the authentication system 100 may include both server side and client side components.

In an example embodiment, service providers may communicate with a device via instant messaging applications, video conferencing systems, VOIP systems, email systems, etc., all of which may be implemented, at least in part, in software 115, 92. In example embodiments, the authentication application/website 206 or trusted application (TEE applet 208) of FIG. 2A may be implemented as an application program interface (API), executable software component, or integrated component of the OS configured to authenticate users on a Trusted Platform Module (TPM) executing on a client computer 150.

Software implementations 115, 92 may be implemented as a computer readable medium capable of being stored on a storage device 95, which provides at least a portion of the software instructions for the user authentication system 100. Executing instances of respective software components of the user authentication system 100, such as instances of the authentication application/website and TEE applet 208, may be implemented as computer program products 115, and can be installed by any suitable software installation procedure, as is well known in the art. In another embodiment, at least a portion of the system software instructions 115 may be downloaded over a cable, communication and/or wireless connection via, for example, a browser SSL session or through an app (whether executed from a mobile or other computing device). In other embodiments, the system 100 software components 115, may be implemented as a computer program propagated signal product embodied on a propagated signal on a propagation medium (e.g. a radio wave, an infrared wave, a laser wave, a sound wave, or an electrical wave propagated over a global network such as the Internet, or other networks. Such carrier medium or signal provides at least a portion of the software instructions for the present user device authentication system 100 of FIG. 2A.

Certain example embodiments of the invention are based on the premise that online services may be significantly enhanced when a device can be trusted to be what it says it is and to execute instructions exactly as asked. A service provider generally has confidence in its servers because they are under administrative control and usually protected physically. However, nearly all of the service provider's services are delivered to users through devices the service provider knows very little about and over which it rarely exerts any control.

Through the use of Trusted Execution technology, certain inventive embodiments are able to provide a service provider with an oasis of trust in the unknown world of consumer devices. Basic capabilities such as “sign this”, or “decrypt this” are executed outside the murky world of the main OS. Keys can be generated and applied without ever being exposed in memory and can be attested to through a chain of endorsements traced back to the device manufacturer.

Certain aspects of the invention enable trust in devices. Some embodiments operate on the fundamental premise that a reliable relationship with a device can make for a much safer, easier and stronger relationship with an end user. Achieving this requires knowing with confidence that a device involved in a current transaction is the same device it was in previous transactions. It also requires assurance that a device will not leak protected information if it is requested to perform sensitive operations such as decryption or signing.

One example preferred embodiment includes device code executed in the Trusted Execution Environment (TEE). The TEE preferably is a hardware environment that runs small applets outside the main OS. This protects sensitive code and data from malware or snooping with purpose-built hardware governed by an ecosystem of endorsements, beginning with the device manufacturer.

### Device Authentication System

FIG. 2A is a block diagram illustrating an example device authentication system 200 according to embodiments of the present invention.

The system 200 includes a user computing device 205 (e.g., mobile device, IoT, PC, and the like) configured with a trusted execution environment (TEE) applet 208, also referred to as a Device Rivet, trusted application, and trusted application code, configured in the TEE of the computing device 205. The user device 205 is communicatively coupled over a computer network to a service provider 204 configured with an encoder 210. The service provider 204 may be executed on a web-based service platform, which may include one or more of an application server, web server, and database servers. A secure socket may be configured to maintain a persistent connection between the user device 205 and service provider 204. The TEE applet 208 of the user device 205 provides hardware-backed cryptographic and authentication services in process transactions with the service provider 204. The value of these services is dependent on the integrity of both the TEE applet 208 and the service provider 204 which accesses the TEE applet 208.

### User Computing Device of System

To provide such integrity, the user device 205 is configured with the TEE. The TEE is a hardware environment where applications (apps) or applets, such as the TEE applet 208 and service provider applications, can be deployed and executed outside, and in isolation from, the primary OS (e.g., Rich OS) on the user device 205. The TEE offers an execution space that provides a higher level of security than the primary OS of the user device 205. Deploying an applet in the TEE of the user device 205 is akin to delivering the applet to a dedicated hardware device. For example, execution and data of the applet is cryptographically isolated from any other function of the user device 205. In an example embodiment, the TEE executing the TEE applet 208 may be implemented on the user device 205 as a mobile phone hardware security chip separate execution environment that runs alongside the primary OS and provides security services to the primary OS environment. In another example embodiment, the TEE may be implemented on the user device 205 as a virtual machine.

There is a class of applications/applets that benefit greatly from the TECC strongly assuring their origin and opaque separation from the execution of other apps, such as block chain (e.g., Bitcoin) related applications. Unlike an application running on the primary OS and memory stack of the user device 205, an application executing in the TEE has access to cryptographic primitives that can be exercised without snooping by the primary OS. On certain platforms, the application also has direct access to user input and display to ensure a private interaction with the user of the user device 205. While a TEE is not as secure as a Secure Element (SE) or subscriber identification module (SIM), the security offered by the TEE is sufficient for many applications executed by the user device 205. In this way, the TEE can deliver a balance allowing for greater security than a primary OS environment, with considerably lower cost than an SE or SIM. While TEE technology has been in development for well over a decade, it is only recently that devices configured with a TEE have become available. For example, Intel began delivery of commercial solutions in 2011, and the joint venture of Trustonic launched in 2013. While most applications of the TEE technology have been concerned with enterprise security or DRM, an embodiment of the invention instead provides an applet that is focused on the needs of common web services.

As with many TEE applets, TEE applet 208 is installed and initialized with a Trusted Application Manager (TAM). The TAM plays a role akin to a certification authority (CA). A TAM secures a relationship with the manufacturer of the user device 205, and also signs all applications that may be loaded onto the user device 205. In this way the TAM provides assurance on the provenance and integrity of both the TEE applet 208, other applications executing on the device in communication with the TEE applet 208, and the TEE.

### Authentication Website (Access Control Server) of System

To further provide such integrity, the user device 205 and service provider 204 are communicatively coupled over a computer network by an authentication website (or other authentication application) 206. The authentication website 206, which may be an API (e.g., JSON API written in Python) to the TEE applet 208 (or other application on or communicatively coupled to the user device 205) comprise several sub-component. The authentication website 206 may comprise a registration agent that enables the user device 205 to register through the authentication website 206. The registration agent may create a unique identifier (e.g., a universal unique identifier (UUID)) and an ephemeral device pointer to the user device 205 that can be requested by a service provider application. The device pointer may be used to identify a current socket session to the authentication website 206 from a service provider application. The current socket session can, in turn, be used to establish a device communication channel to the authentication website 206 from the service provider application and look up the unique device identifier of the user device 205.

The registration agent may also register a block chain account key (a digital cryptographic public/private key pair) for the user device 205 that can be referenced as a signatory in transactions on the block chain. In some embodiments, multiple block chain account keys may be registered. The registration agent may call the TEE applet 208 to create hardware keys, such as the block chain account key, at the user device 205. Different types of hardware keys are available depending on the purpose for creating the hardware keys, such as for crypto-coins or data encryption. The creation of the hardware keys by the registration agent are governed by simple usage rules established during creation. For example, a hardware key may require that usage requests are signed by the service provider 204 that created the key, or that the user confirms access through a Trusted User Interface (TUI). The registration agent may also create a unique device identifier for referencing the user device.

In some embodiments, the unique device identifier and block chain account keys are stored locked in the TEE of the user device 205, in other embodiments, the unique device identifier and block chain account key are stored in another secure memory location accessible to the registration agent. In example embodiments, a signatory value represented in the block chain transaction cannot be spent or transferred unless co-signed by the registrar agent using the block chain account key (in particular the private key). The device registration may include the unique device identifier, the device pointer, a registration date, the public key paired of the user device 205, and an endorsement signature from the registration agent. This information is recorded in a device registration record accessible by the registration agent. The registration agent, through the authentication website 206, may similarly enable the service provider 204 to register with the authentication website 206, including creating a block chain account key (a public/private key pair) for the service provider 204 and recording a registration record for the service provider 204.

Through the registration, the authentication website 206 is the first application (provider of a service) associated with the TEE applet 208 of the user device 206. The authentication website 206 (via the registration agent or other agent coupled to the authentication website 206) has the special capability of being able to act as a broker and associate (pair) service providers, such as service provider 204, with that user device 205. The authentication website 206 is able to conduct the pairing because it can confirm the integrity and identity of both the user device 205 and the service provider 204 using their device registration records. As part of the pairing, the authentication website 206 may load the user device 205 with the public key of the service provider 204 and of the user device 205, which may be stored by the user device 205 in the TEE. By storing the public keys of the service provider 204 at the TEE, the TEE applet 208 of the user device 205 can validate the origin of an instruction received from the service provider 204, and if needed, decrypt the contents of a received instruction from the service provider 210.

The authentication website 206 may also provide the service provider 204 with the unique device identifier and public key of the user device 205, which the service provider 204 may store in memory communicatively coupled to the platform of the service provider 204. In some embodiments, the authentication website 206 may also format the pairing as a pairing registration record, including the unique device identifier and public key of the user device 205 and public key of the service provider 204. The authentication website 206 may then record the pairing registration record in the block chain (associated to the block chain public key of the user device 205 and service provider 204) or other secure memory communicatively coupled to the platform of the authentication website 206. In other embodiments, the authentication website 206 instead updates the device registration record with the pairing information.

The authentication website 206 may also generate an access control list (also referred to as a trusted execution list) through an access control application, where controls related to the execution of a received instruction within the pairing can be configured and verified. The digital cryptographic keys that have been previously registered with the TEE applet 208 may be stored in an access control list. Specific controls may be associated with a particular registered cryptographic key. For example, the access control list may indicate the authorized period of time for executing an instruction, whether the instruction is within a limit on the number of executions, and whether the instruction is associated with an external condition (factor) that must be verified prior to execution of the instruction. The authentication website 206 may also maintain log data on whether a received instruction is executed, the number of times an instruction is executed within a pairing, reasons for an instruction failing to be executed by the user device 205, and such. The authentication website 206 may then record the access control list and log in the block chain (associated to the block chain public key of the user device 205 and service provider 204) or other secure memory communicatively coupled to the platform of the authentication website 206.

### Communication and Execution of System

Once the authentication website 206 pairs the user device 208 with the service provider 204, the service provider 204 may send instructions to the user device 208 for performing transactions (e.g., transfers of value, such as a purchase). The service provider 204 prepares an instruction (e.g., at the application server of the service provider platform) for execution by the user device 205. The instruction may include the instruction type, the user device (e.g., device identifier), and payload of the instruction. The service provider 204, using the encoder 210, signs the instruction using the public key of the service provider 204. In some embodiments, the service provider 204, using the encoder 210, also (or instead) encrypts the instruction using the public key of the user device 205. In embodiments, the signing ceremony is executed in secure hardware such that the key is never exposed to normal processing environment of the device. An encryption key can be generated on request and applied to any portion of data. Encryption and decryption may be triggered locally and take place within the secure execution environment so as to protect the key. In Bitcoin embodiments, in creating a Bitcoin account, the device can be requested (e.g., by that authentication website 206) to generate a new Bitcoin account using the random number generator (RNG) built into the TEE. The device can apply its private Bitcoin account key to sign a transaction and then return the transaction to the service provider.

In some of these embodiments, the service provider may retrieve the public key of the user device 205 stored in memory communicatively coupled to the platform of the service provider 204. In other of these embodiments, the service provider may request the public key of the user device 205 from the authentication website 206, which retrieves this public key (e.g., using the device identifier) from the device registration record for the pairing stored in the block chain or other secure memory communicatively coupled to the platform of the authentication website 206. In other example embodiments, the service provider 204 communicates the instruction to the authentication website 206, which sign and/or encrypts the instruction by retrieving (e.g., using the device identifier) the device registration record for the pairing stored in the block chain or other secure memory communicatively coupled to the platform of the authentication website 206.

The service provider 204 then sends the signed and/or encrypted instruction to the user device 205. In some embodiments, the service provider 204 sends the signed and/or encrypted instruction to the authentication website 206, which may perform validation on the instruction, prior to sending the instruction to the user device 205 based on information stored for the user device 205 during registration. For example, the authentication website 206 may perform health and integrity checks on the user device 205 prior to sending to the user device 205, verify that the signature matches the service provider 204, verify external conditions specified in the access control list, and such. In other embodiments, the service provider 204 may directly transmit the instruction to the user device 205. The user device 205 receives the signed and/or encrypted instructions and the TEE applet 208, and may verify the instruction based rules (e.g., internal and external device conditions) in the access control list for the pairing, including rules attached to the service provider key used to sign the instruction.

Once any attached rules are verified, if the instruction is signed, the TEE applet 208 verifies that the signature of the instruction matches the public key of the paired service provider 204. The TEE applet 208 may access this public key stored in the TEE of the user device 205 or request this public key from the authentication website 206. If the instruction is encrypted, the TEE applet 208 may also decrypt the instruction using the public key of the user device 205. The service provider key 204 used to sign the instruction may be encumbered with restrictions (as specified in the access control list), such as requiring user acknowledgement or authorization from a remote process prior to execution of the instruction. The restrictions may be coupled to the public key of the user device. Without passing these encumbrances, the TEE applet 208 cannot execute the instruction. Access to the TEE applet 208 (trusted application) may be further controlled by business rules (external conditions) imposed by the authentication website 206 (e.g., in the access control list), such as number of executions allowed or active time period. If all encumbrances/rules are met, the TEE applet 208 may then execute the instruction within the TEE (or primary OS) of the user device 205 and generate execution results.

The user device 205 signs the execution results using the public key of the user device 205. In some embodiments, the user device 205, also (or instead) encrypts the execution results using the public key of the service provider 204. In some of these embodiments, the user device 205 may retrieve the public key of the service provider 204 stored in memory at the TEE of the user device 205. In other of these embodiments, the user device 205 may request the public key of the service provider 204 from the authentication website 206, which retrieves this public key from the device registration record for the pairing stored in the block chain or other secure memory communicatively coupled to the platform of the authentication website 206. In other example embodiments, the user device 205 communicates the instruction to the authentication website 206, which sign and/or encrypts the instruction by retrieving (e.g., using the unique device identifier) the device registration record for the pairing stored in the block chain or other secure memory communicatively coupled to the platform of the authentication website 206.

The user device 205 then sends the signed and/or encrypted execution result to the service provider 204. In some embodiments, the user device 205 sends the signed and/or encrypted execution result to the authentication website 206 as a broker. The authentication website 206 may update in the maintained log data record in the block chain or other secure memory communicatively coupled to the platform of the authentication website 206 to indicate successfully execution of the instruction. The authentication website 206 may also perform validation on the instruction, prior to sending the execution result to the service provider 204 based on information stored for the service provider 204 during registration. For example, the authentication website 206 may perform health and integrity checks on the user device 205 prior to sending to the service provider 204, verify that the signature matches the user device 205, and such. In other embodiments, the user device 205 may directly transmit the execution result to the service provider 204. The service provider 204 receives the execution (instruction) results and may apply rules attached to the signed public key prior to processing the execution results. The service provider 204 receives the signed and/or encrypted execution result, and if the execution result is signed, verifies that the signature of the execution results matches the public key of the paired user device 205. The service provider 204 may access this public key stored in secure memory communicatively coupled to the platform of the service provider 204, or request this public key from the authentication website 206. If the execution result is encrypted, the service provider 204 may also decrypt the instruction using the public key of the service provider 204. The service provider 204 may notify the authentication website 206 of the successful receipt of the execution results, which the authentication website 206 updates in the maintained log data record in the block chain or other secure memory communicatively coupled to the platform of the authentication website 206.

In other embodiments, the user device 205 may instead prepare, sign, and encrypt an instruction, which is sent to the service provider for execution. In these embodiments, the service provider 204 may verify the signature, decrypt, execute, and returns execution results (signed and decrypted) to the user device 205.

### First Example Device Authentication Components

FIG. 2B is a block diagram illustrating components of the device authentication system 200 according to an example embodiment of the present invention. In the embodiment of FIG. 2B, the service provider 204 comprises a service provider website 204a and a service provider client application (app) 204b, which may be executed on a web server, application server, or such of the service provider platform. The service provider website 204a is communicatively coupled to the authentication web site 206 (configured at an access control server) over a secure socket connection. This secure connection is used for pairing and other administrative functions. The service provider 204, via the service provider website 204a, may register (enroll) with the authentication website 206, which may create a block chain account key (public and private key pair) for the service provider 204. The authentication website 206 may store the block chain account key in secure memory communicatively coupled to the authentication website 206 (configured at an access control server). The authentication website 206 may also return the block chain account key to the service provider website 204a, which may store the block chain account key in secure memory communicatively coupled to the service provider 204. The authentication website 206 may perform the recordation using a device registration record that contains a unique, anonymous identifier, a registration date, the public key held in the device hardware, and an endorsement signature from the authentication website 206.

In the embodiment of FIG. 2B, the user device 205 comprises an adapter 214 and TEE applet 208. The adapter 214 is communicatively coupled to the authentication website 206 (configured at an access control server) over a secure socket connection. This secure connection is used for pairing and other administrative functions. The adapter 214 is a software service running on the endpoint user device 205 that provides an interface to the service provider 204 application and integrates with the TEE applet 208. The adapter 214 is configured as the interface between the TEE applet 208 installed at the TEE of the user device 205 and the external applications and online services. The TEE applet 208 is a software program that executes in a hardware secured TEE environment of the user device 205 (in isolation from the primary OS of the user device 205). The TEE applet 208 embodies the binding between the physical and digital works. The TEE applet 208 is specially designed to securely execute cryptographic functions without the functions being compromise from malware or the device operator. The TEE applet 208 locks features of identity, transaction and attestation to hardware of the user device 205.

When the adapter 214 first initializes, the adapter 214 registers (enrolls) the user device 205 with the authentication website 206, which may create a block chain account key (public and private key pair) and unique device identifier for the user device 205. The authentication website 206 may also return the block chain account key and unique device identifier to the service provider website 204a, which may store the block chain account key in secure memory communicatively coupled to the service provider 204. The authentication website 206 may also record the block chain account key and device identifier in the block chain or other secure memory communicatively coupled to the authentication website 206. In other embodiments, when the adapter 214 first initializes, the adapter 214 requests the TEE applet 208 to generate a public and private key pair and/or unique device identifier for the user device 205. In these embodiments, the adapter 214 registers the user device 205 with the authentication website 206 by providing the generated public and private key pair and/or unique device identifier to the authentication website 206. The TEE applet 208 may also store the public and private key pair and/or unique device identifier at the hardware of the user device 205. The authentication website 206 may record the block chain account key and device identifier in the block chain or other secure memory communicatively coupled to the authentication website 206. The authentication website 206 may perform the recordation using a device registration record that may contain a unique, anonymous identifier, the unique device identifier, a registration date, the public private key pair, an endorsement signature from the authentication website 206, and the like.

Other user devices may similarly register with the authentication website 206. For example, a user may possess multiple user devices that may each be similarly registered with the authentication website 206.

The authentication website 206 may then act as a broker and pairs the user device 205 to the service provider 204. As part of the pairing, the authentication website 206 may provide the user device 205 with the public key of the service provider 204, which may be stored by the user device 205 in the TEE. The authentication website 206 may also provide the service provider 204 with the unique device identifier and public key of the user device 205, which the service provider 204 may store in secure memory communicatively coupled to the platform of the service provider 204. In some embodiments, the authentication website 206 may also format the pairing as a pairing registration record, which the authentication website 206 records in the block chain or other secure memory communicatively coupled to the authentication website 206. The authentication website 206 may also create an access control list for the pairing that specifies the authorized period of time for executing an instruction, whether the instruction is within a limit on the number of executions, and whether the instruction is associated with an external condition (factor) that must be verified prior to execution of the instruction, and such. The authentication website 206 may also maintain log data on whether a received instruction is executed, the number of times an instruction is executed within a pairing, reasons for an instruction failing to be executed by the user device 205, and such.

The authentication website 206 is communicatively coupled over a secure connection to a ring manager 212, which may be implemented as a service provided to end-users for managing collections (or rings) of user devices registered with the authentication website 206. Preferably, every user device 205 should present unique identity credentials, but the user devices of a given user 205 may join a ring to act as a singular entity. Device can be joined to share and backup identities, as most users have several devices. Certain embodiments enable multiple devices to be bound into a ring so the devices can interchangeably present themselves to a service provider on behalf of the user.

In embodiments, the ring manager 212 groups (or pairs) these devices of the given user into a single identity (e.g., ring key), and the user devices use that single identity to backup and endorse each other (e.g., the group may share block chain accounts and associated wallets). The ring manager 212 may further associate a ring of user devices with rings of other devices to create a network of devices. In some embodiments, the ring manager 212 may identify a ring of user devices as a collection of individual device public keys (as opposed to generating a new ring key). If there are not many shared devices in the environment, the group of devices may be short because of the potential for increased computational and bandwidth resources expended and time cost introduced in order to encrypt a message with all of the public keys of the device group. In an example embodiment, a ring may be implemented as a shared private key on top of the unique private key of each user device. It should be noted, however, it is not typical to share a private key, nor would it be desirable to have a long-lived shared symmetric key. The authentication website 206 or ring manager 213 may record a grouped ring of user devices at the block chain, or other secure memory communicatively coupled to the authentication website 206 and/or ring manager 213.

In one embodiment, a user device 205 can support group identifiers that are locally stored as a list, but publicly translate into cross-platform authentication. In implementation, it can manifest in one or more diverse forms, which would be at least partially dictated by the basic capabilities across devices, hardware support and OS architecture.

The service provider 204, via the service provider website 204a, may construct an instruction (e.g., value transfer for a purchase) for execution by the TEE applet 208 of the user device 205. The instruction may contain the instruction type, device identifier, and payload of the instruction. The service provider website 204a signs the instruction using the service provider's public key, and may also encrypt the instruction with the user device's public key. The service provider website 204a accesses library (encoder) 209 may for simplifying the construction and signing of an instruction. This library 209, for example, could be implemented in a programming language, such as an object-oriented, high-level programming language with dynamic semantics like Python. In some embodiments, the service provider website 204a communicates the signed/encrypted instruction to the authentication server 206, which may perform verification (e.g., check an external condition in the access control list) on the signed/encrypted instruction, and accesses a pairing registration record (e.g., using the device identifier). Based on the pairing registration record, the authentication server 206 sends the instruction to the adapter 214 of the user device 205. In other embodiments, the service provider client app 204b sends the instruction directly to the adapter 214 of the user device 205 based on the device identifier.

The adapter 214 passes the signed/encrypted instruction to the TEE applet 208. The TEE applet 208 will only execute and respond to an instruction from a service provider that has been paired with the user device 205, such as service provider 204 of FIG. 2A. The TEE applet 208 verifies any rules (e.g., internal or external conditions) associated to the public key, or other rules in the access control list. The TEE applet 208 verifies the signature of the TEE applet 208 using the public key of the service provider either stored at the TEE or requested from the authentication website 206 based on the pairing. If the instruction is encrypted, the TEE applet 208 decrypts the instructions using the public key of the user device 205. Once the instruction is verified and decrypted, the TEE applet 208 executes the instruction within the TEE of the user device to generated execution results. The TEE applet 208 may sign and/or encrypt the execution results, and send the execution results (via the adapter 214) to the service provider 204.

Inventive API's enable secure execution of a number of sensitive device-side transactions, including: getting a reliable and anonymous device id—on request, an embodiment of the invention will generate a signing key for a device. These APIs may include features such as to create a device key, delete a device key, attach rules to a device key, sign a device key, and encrypt a device key. An embodiment of the invention provides a native API that translates calls into a secure environment. While different TEE environments follow very different architectures, the API of an embodiment of the invention is designed to present a uniform interface to the application.

### Second Example Device Authentication Components

FIG. 2C is a block diagram illustrating components of the device authentication system 200 according to another example embodiment of the present invention. In the embodiment of FIG. 2C, the adapter 214 is a software service running on the endpoint user device 205 that provides an interface to the service provider 214. The service provider 204 is an application executing on a web-based platform and seeking to conduct a transaction (e.g., value transfer) with the user device 205. The adapter 214 integrates with the TEE applet 208 of the user device 205. The TEE applet 208 is a software program that executes in a hardware-secured TEE of the user device 205 and is specially designed to execute cryptographic functions without being compromised from malware or even the device operator. In the embodiment of FIG. 2C, the adapter 214 is further integrated with a registrar 221 of the user device 205, which is a service that registers a device into a communicatively coupled block chain 222. The registrar 221 uses the block chain 222 both to store device registration and attributes and to execute transactions. In some embodiments, the registrar may be communicatively coupled to one or more different block chains.

The registrar 221 and TEE applet 208 are communicatively coupled to an Original Equipment Manufacturer (OEM) 223, which is the entity that built the user device 205 and/or a Trusted Application Manager (TAM) authorized to cryptographically vouch for the provenance of the user device 205. The TAM plays a role akin to a certification authority (CA). A TAM secures a relationship with the manufacturer of the user device 205, and also signs all applications that may be loaded onto the user device 205. In this way the TAM provides assurance on the provenance and integrity of both the TEE applet 208 and the TEE.

In FIG. 2C, when the device adapter 214 executes for the first time, it will request the TEE applet 208 to generate a public/private key pair for the block chain 222. The TEE applet 208 generates the public key and signs the generated public key by an endorsement key established during device manufacturing (e.g., by the OEM).

The TEE applet 208 (via the adapter 214) sends the signed public key to the registrar 221, which validates the signed public key with the OEM 223 to ensure provenance. The registrar 221 may also record the context of the registration to ensure that trust is being extended. For example, the registrar 221 testing an OEM endorsement key makes it vastly more certain that the TEE applet 208 is operating in a proper TEE.

The registrar 221 may then register the signed public key for association with the user device 205. The registrar 221, or another trusted integrity server, may further create a block chain account key (the public key and an associated private key pair) that can be referenced as a signatory in a multi-signature transaction on the block chain 222. A signatory of value represented in a block chain transaction cannot be spent or transferred unless co-signed by the registrar 221. The registration may also involve confirmation from the device operator (use) and endorsement at the point of sale in the presence of a clerk. The registrar 221 may then hash the public key into a string that can be used to identify and communicate with the user device 205, and store the public key at the block chain, or other secure memory communicatively coupled to the registrar 221. The private key paired with the public key of the user device 205 remains locked in the hardware (TEE) and can only be applied by the TEE applet 208 on behalf of the paired service provider 204.

The registrar 221, as part of the registration, may also request a device measurement record from the user device 205 which includes one or more of the following data: a composite value of platform configuration registers (PCRs) generated by the boot process, BIOS Version, OS Version, GPS location. The public key is signed by an endorsement key established during device manufacturing. The TEE adapter 214 signs the data using the private key and the registrar 221 further signs the data. The resulting signed data set becomes the gold reference or reference value for future integrity checks of the user device 205. The registrar 221 may require confirmation from the device operator in collecting the gold reference or reference value. The registrar 221 then records the data set in the block chain 222 (or other public cryptographic ledger, such as Namecoin). The public record establishes cryptographic proof of the time of registration of the user device 205, along with the endorsement of the registrar 221 to the recording. The public record may further include attribute data of the user device 205, such as location or company name or device make/model. The registration of the user device 205 may further reference a signed document that sets out the policy terms of the registrar at the time of registration.

Enrollment enables the TEE applet 208 to pair a user device 205 with a service provider 204. The result of pairing is that a user device 205 has a service public key, which may be endorsed by a third party provisioning agent, and can therefore respond to service provider 204 instructions.

The registrar 221 or TEE applet 208 pairs the user device 205 to the service provider 204, which includes the device adapter 214 providing the hashed public key to the service provider 204 to verify signed messages received from the user device 205. The user device 205 (via the device adapter 214) also receives the hashed public key of the service provider 204, which is stored in the TEE accessible to the TEE applet 208. The result of pairing is that the user device 205 possesses the public key of the service provider 204, endorsed by a third-party agent/process (e.g., the device registrar 221) and can therefore respond to instructions (transactions) from the service provider 204.

The service provider 204 may then send transaction requests (instructions) to the user device 205 (via the device adapter 214) signed with the public key of the service provider 204. While third-party agent/process may be used locally to generate the transaction request, ideally all transactions (instructions) are signed by the service provider 204. This protects a device key from being applied by a rogue application.

The TEE applet 208 receives the transaction from the adapter 214 and verifies, using the stored public key of the service provider 204, the signature of the transaction. Once verified, the TEE applet may proceed to execute the transaction.

The registrar 221 may further provide device integrity attestation by automating the assurance of device integrity against a known state as a signatory on a block chain transaction. In particular, the registrar 221, or another trusted integrity server, may sign the transaction using the private key to prove that the user device 205 was involved in the execution of the transaction. The registrar 221 may then record the signed (proven) transaction in the block chain 222. To sign the transaction, registrar 221 requires a current measurement from the user device 205. The registrar 221 may request the current measurement directly from the adapter 214 or fetched the current measurement through a persistent sockets connection with the TEE applet 208. The requested/fetched current measurement is compared against the gold measurement or reference value for the user device 205 recorded in the block chain. If the current measurement matches the recorded measurement, the registrar 221 signs the executed transaction. If the measurements match but the current measurement is older than a specified time window, or the measurement do not match, the registrar 221 rejects the transaction. The registrar may be configured with policy rules to accept a measurement which does not match, if the rules indicate that the rejection is not deemed severe in light of other matching measurements or attributes. For example, if the transaction is rejected, the transaction may have been prepared with another manual signatory that can be asked to override the rejection. If the measurements do not match, the device may also be put through a registration renewal where a new measurement is gathered by the registrar 221. Every time a measurement matches, the device registration record may be updated with a success count.

In some embodiments, the registrar (integrity server) 221 may be replaced with a collection of trusted devices rather that functions to match device measurements (current and recoded) and sign the transaction. The registrar 221 (or collection of trusted devices) may match integrity measurements directly during transaction processing using features (e.g., smart contracts) built into a smart block chain system, such as that being developed by Ethereum.

### Third Example Device Authentication Components

FIG. 2D is a block diagram illustrating components of the device authentication system 200 according to a further example embodiment of the present invention. In FIG. 2D, the adaptor 214 is composed of outward and inward looking interfaces. The inward looking interface, the TEE adapter 216, handles proprietary communications with the TEE applet 208. The TEE adaptor 216 component is the proprietary glue that pipes commands into the TEE applet 208. A first outward looking interface, the host adaptor 217, exposes services to third-party applications. The host adaptor 217 presents the interface of the adaptor 214 through different local contexts, such as browsers or system services. The host adapter 217 may be an Android service, a windows .com process, or such. A second outward look interface, the socket adaptor 215, connects the client environment of the user device 2015 to the authentication web site 206.

In an Android implementation, the adaptor 214 may manifest as an Android NDK service app and may be configured to launch at boot. The adaptor 214 prepares message buffers that are piped to the TEE applet 208 and then synchronously awaits notification of a response event. The host adaptor 217 is primarily there to isolate the TEE adapter 216 from the host environment. The host adaptor 217 operates in a potentially hostile environment. There will therefore typically be limited assurance that the user device 205 has not been compromised. The role of the host adapter 217 is therefore primarily to facilitate easy access to the TEE applet 208. Instructions received from a third-party component (e.g., service provider 204) intended for the TEE applet 208 are signed/encrypted by the third-party component and then passed through the host adapter 217 to the TEE adapter 216 and TEE applet 208.

Communications with the authentication website 206 may be handled through the web API and should be authenticated. In one example, this is implemented with an API key. In a preferred example embodiment, this is implemented using an SSL key swap. In some embodiments, all requests will be signed. The relationship with devices may be dependent on being able to sign instructions with the private key. Such a private key is highly sensitive and is protected. Preferably, the private key is encased in an HSM. In some embodiments, multiple keys are used, such that if one is compromised the whole system is not lost. This should, for example, should make it more difficult for an attacker to know which devices are connected with a compromised key. Furthermore, the system 200 is preferably in near constant contact with all user devices 205 through the socket adapter 215 shown in FIG. 2C, which can facilitate frequent rotation.

### Protocol for Enrolling Device

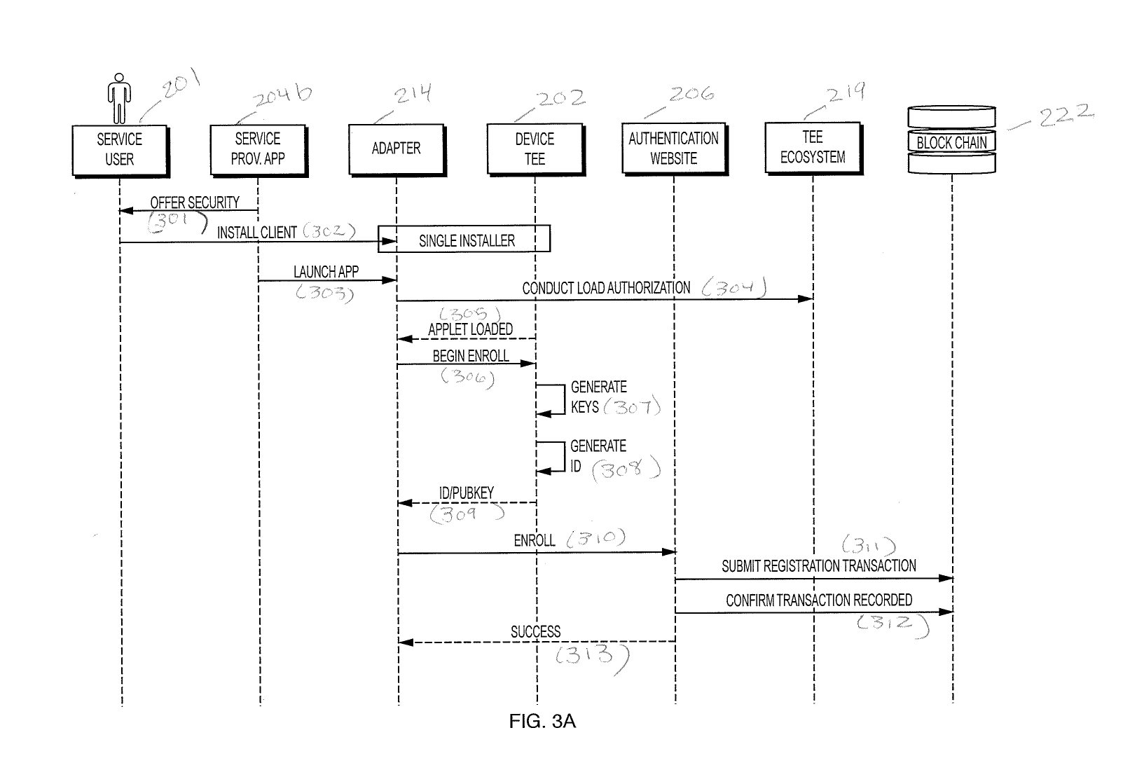

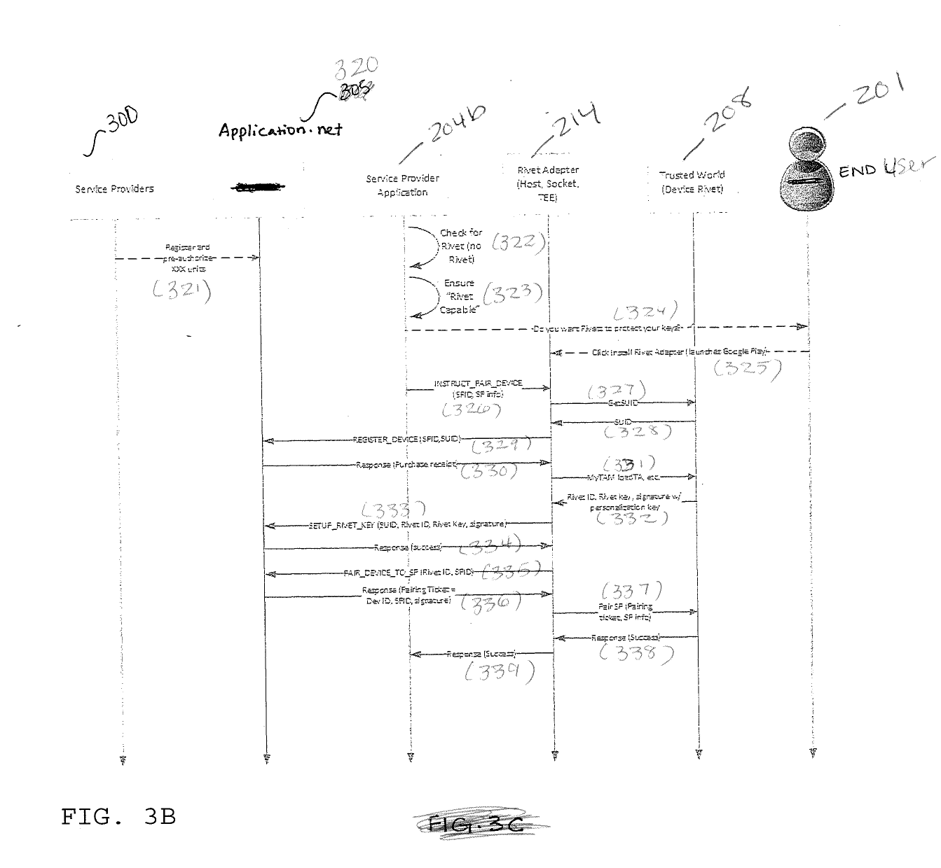

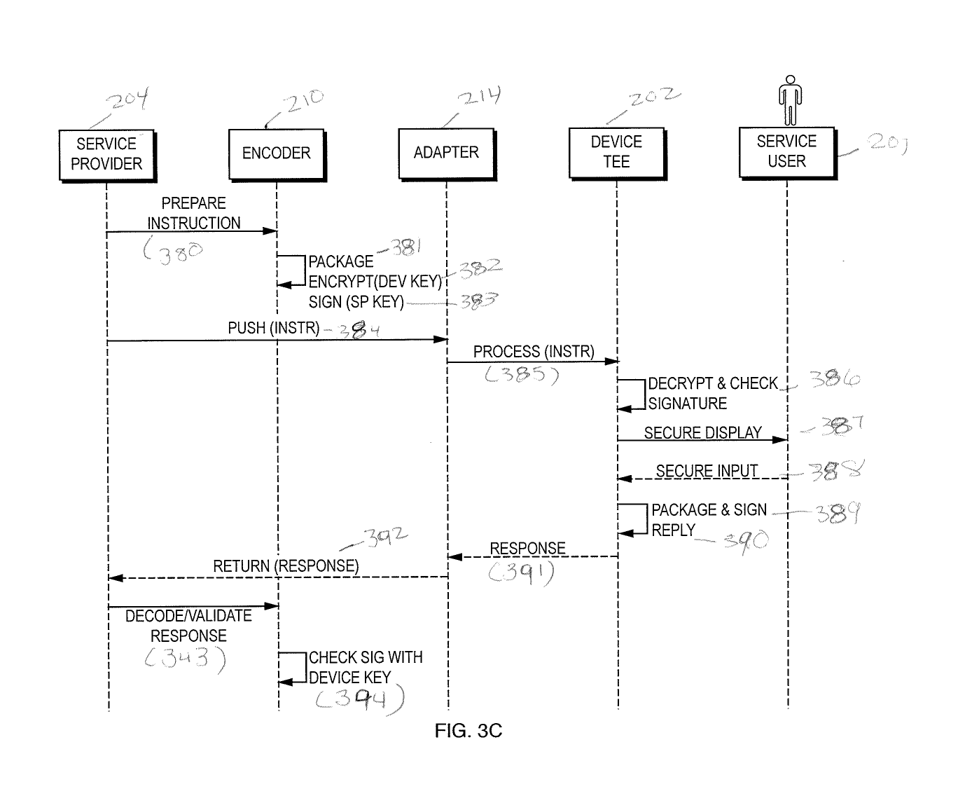

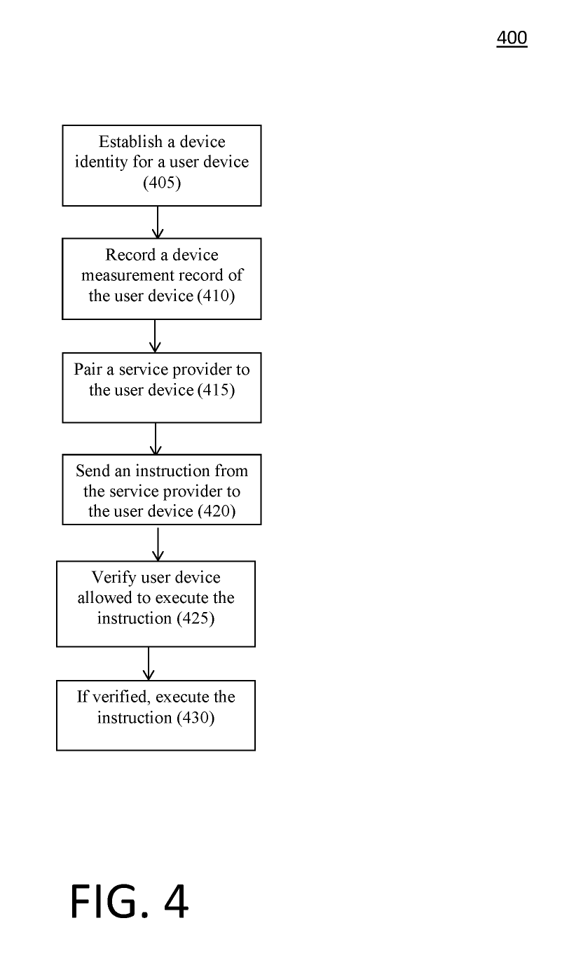

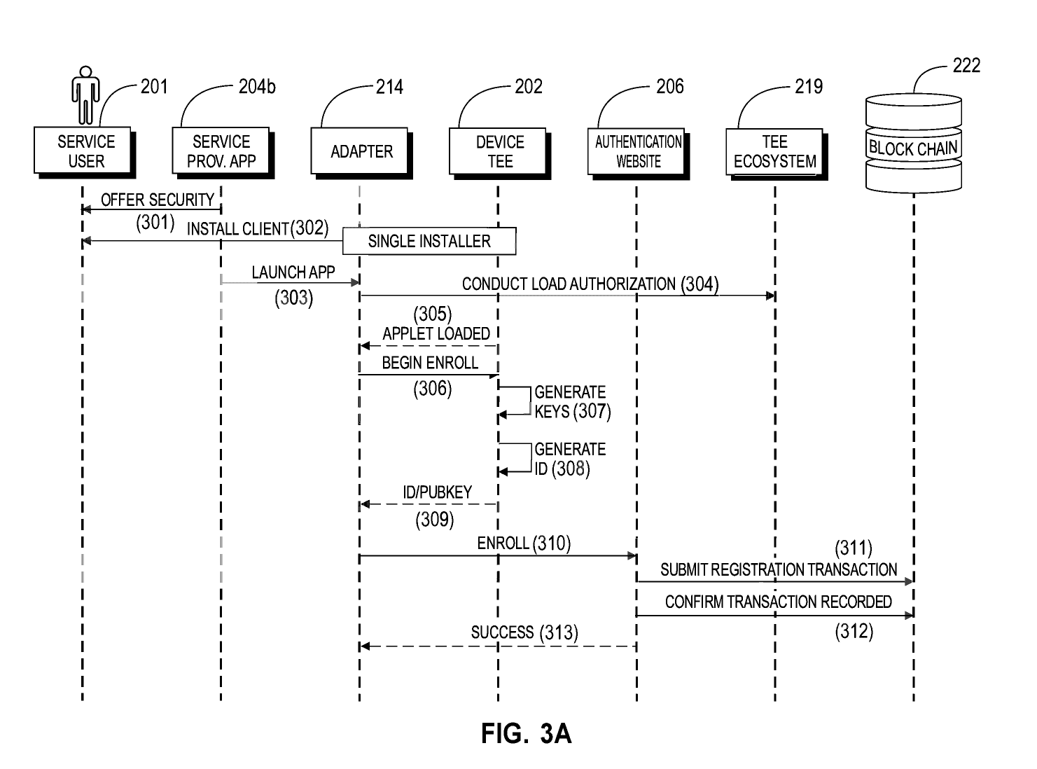

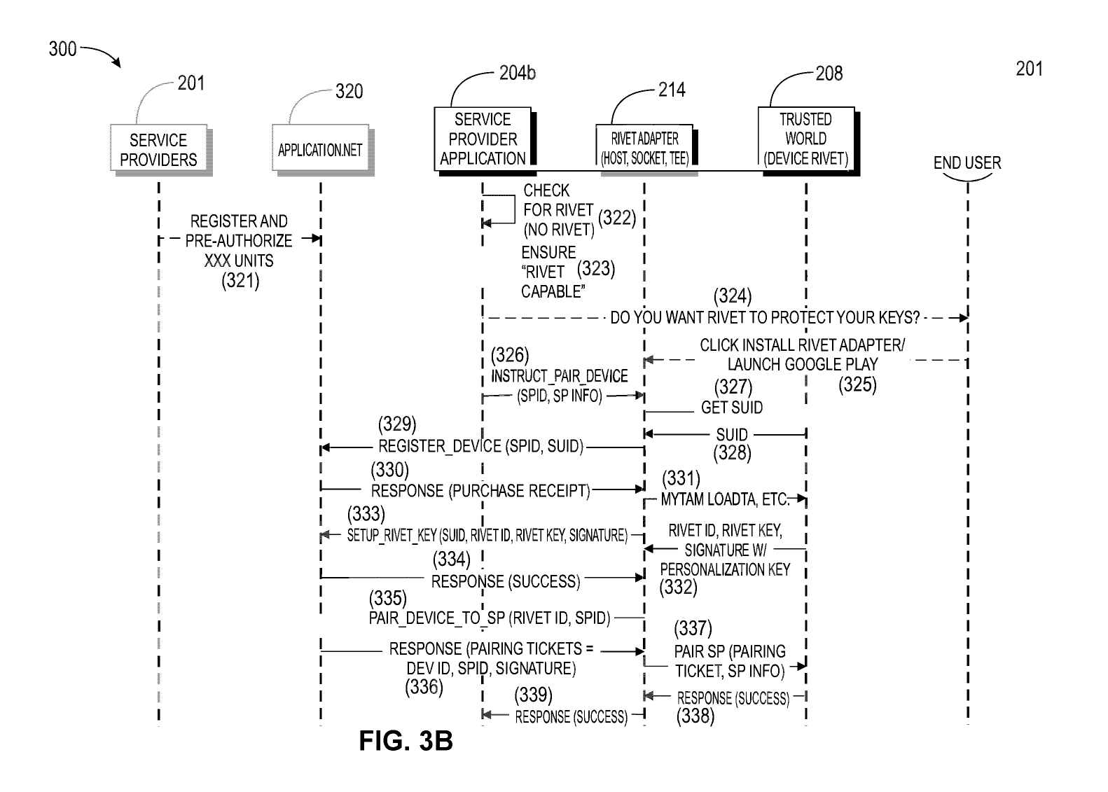

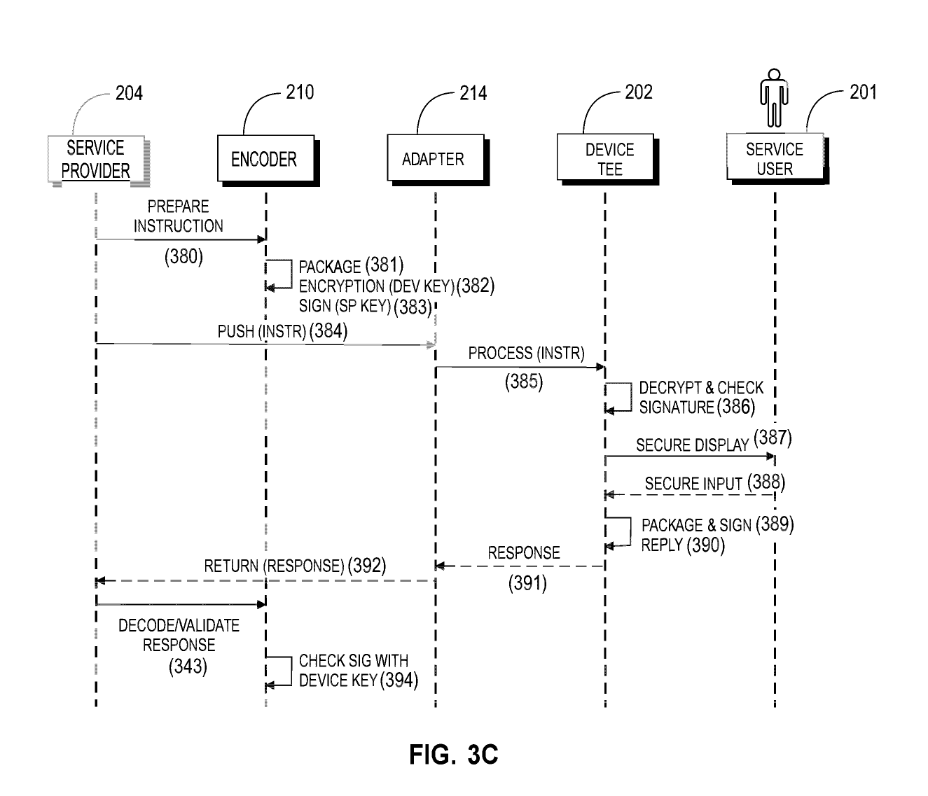

FIG. 3A is a diagram of an example protocol for enrolling a device in example embodiments of the present invention. The enrollment protocol enables a service provider 204 to obtain and confirm the identity of the user device 205.

FIG. 3A includes a service user 201 associated with a user device 205 configured with a TEE environment. The service provider 204 offers 301 the service user 201 (e.g., via a web browser interface configured on the user device 205) security. In response, the service user 201 accepts the offer, installs 302 (via the service provider app 204b executing a single installer) components of the client at the device TEE 202, including the adapter 214 and TEE applet 208 of the user device 205. The TEE applet 208 may comprise application code that is executed in isolation (in the TEE 202) from the primary OS of the user device 205. This TEE applet 208 (trusted device application code or trusted application) provides hardware-backed cryptographic and authentication services to multiple third party applications, including service provider 204. The value of these services is dependent on the integrity of both the TEE applet 208 (trusted application) and the third party applications (e.g., service provider 204) that access the trusted application. To assert trust, the trusted application may be installed in the device's TEE per existing industry TEE provisioning mechanisms.

The service provider app 204b then launches 303 an application (app) at the adapter 214 of the user device 205, which causes the adapter 214 to conduct 304 load authorization by communication with the TEE ecosystem 219 that governs the device TEE 202, including loading 305 the TEE applet 208. The device TEE 202 notifies that adapter 214 of the loaded application and the adapter 214 initiates 306 the device enrollment process (protocol) at the device TEE 202 (via the TEE applet 208). Device enrollment (or registration) with the service provider 204 (via the authentication website 204) is essential in example embodiments of the invention. The device enrollment process is hassle free or even transparent to the user.

As part of the enrollment protocol, the first time the adapter 214 software runs, the adapter 214 requests the TEE applet 208 (within the device TEE 202) to generate a device key 307 (digital cryptographic public and private device key pairing) and a unique device identifier 308 for the user device 205. In some embodiments, multiple device keys and/or identifiers may be generated. In some embodiments, the TEE applet 208 may communicate with a third-party service to generate the device keys and device identifier. The TEE applet 208, or a provisioning agent configured in the TEE environment, may sign the public key by an endorsement key established during device manufacturing. The TEE applet 208 passes 308 the generated public device key of the device key pair and the generated device identifier to the adapter 214. The adapter 214, in turn, transmits 310 an enrollment registration request transaction to the authentication website 206 (as described in reference to FIG. 2A) that includes the generated public device key and device identifier.

The authentication website 206 receives the enrollment registration request transaction, performs any necessary verification related to the transaction, such as validating the public key with the OEM, and submits (records) the transaction to the block chain. The authentication website 206 may record (submit) 311 the transaction at the block chain as a device registration record that may include the device identifier, a device pointer, a registration date, the public key of the user device 205, and an endorsement signature from the authentication website 206. The authentication website 206 further confirms 312 that the transaction (device registration record) is recorded at the block chain. The authentication website 206 then reports 313 that the registration of the user device 205 was successful to the adapter 214 of the user device. The authentication website 206 (access control server) can manage access to the TEE applet 208 (trusted application) by the service provider 204.

### Protocol for Pairing Device

FIG. 3B is a diagram of an example protocol for pairing a device to service providers 300 in example embodiments of the present invention.

A given service provider (service provider 204) sends 321 a request to the authentication website (Application.net) 320 to register and pre-authorize with one or more user devices (units), including user device 205. The service provider 204 has already registered its cryptographic identity (e.g., digital cryptographic public key) with the authentication website 320 (access control server). The authentication website 320 executes a service provider application 306 that checks 322 its records or communicates with the user device 205 to determine if the user device 205 is configured with a TEE applet 208 (i.e., a device Rivetz) for securely generating and protecting cryptographic keys. If not, the service provider application 306 checks 323 its records or communicates with the user device 205 to determine if the user device 205 is capable of being configured with the TEE applet 208. If the user device 205 is determined to be capable of being configured with the TEE applet 208, the service provider application 306 sends 324 a message to the service user 201 (e.g., via a web browser interface of the user device 205), asking if the end user 201 would like to use the TEE applet (Rivetz) to protect the end user's keys. If so, the end user 201 may click 325 an install option in the message, which launches an application (e.g., via Google Play) to install the adapter 214 and TEE applet at the user device 205, such as in the TEE of the user device 205. In some embodiments, the install option may proceed to install the user device 205 at the user device TEE as shown in FIG. 3A.

After installation, the service provider application 204b sends 326 a message (INSTRUCT_PAIR_DEVICE) containing the service provider identifier (SPID), service provider cryptographic key (e.g., public key), and other service provider information to the adapter 214 of the user device 205. The adapter 214 sends 327 a request (GetSUID) to the TEE applet 208 to return the identifier (SUID) binding the end user 201 to the user device 205, which is securely recorded in the TEE of the user device 205. The TEE applet 208 responds 328 to the request with the end user identifier (SUID), which the adapter 214 sends 329 to the authentication website 320 in a registration message (REGISTER_DEVICE) containing the service provider identifier (SPID) and the device identifier (SUID). The authentication website 320 performs any necessary verification on the registration and responds 330 to the adapter 214 confirming the registration (e.g., with a purchase receipt). In response the adapter 214 requests the TEE applet 208 to create 331 an instance with a TAM to signs applications (such as the application of the service provider 204) that may be loaded onto the user device 205, loads a TA, and such. The TEE applet 208, in communication with the TAM, generates 332 a unique device identifier (Rivet ID), a device key (public private key pairing), and returns to the adapter 214 the unique device identifier (Rivet ID), the public device key (Rivet key), and signature with public (personalized) key of the end user 201.

In response, the adapter 214 transmits 333 a command (SETUP_RIVET_KEY) containing the end user identifier (SUID), unique device identifier (Rivet ID), public device key (Rivet key), and signature to the authentication website 320. Through this public device key (Rivet key), the authentication website 204 (access control server) obtains cryptographic assurance of the integrity of the instance of the TEE applet 208 (trusted application). The authentication website 320 performs any necessary actions on the request (e.g., record a device registration record at the block chain for the registration), and responds 334 to the adapter 214 that the registration has succeeded. The adapter 214 then sends 335 a command (PAIR_DEVICE_TO_SP) containing the unique device identifier (Rivet ID) and the service provider identifier (SPID). The authentication website 320 generated a device identifier (DEV ID) for the pairing and responds 336 to the adapter 214 with a pairing ticket containing the pairing device identifier (DEV ID), the service provider identifier (SPID), and the service provider key (public key) signed by the authentication website 320 (access control server).

The adapter 214 transmits 337 a command (Pair SP) containing the pairing ticket and other service provider information to the TEE applet 208 to store the pairing information in the TEE of the user device 205. Once the pairing is successfully stored, the TEE applet 208 responds 338 to the adapter 214 that the pairing is a success. The adapter 214, in turn, responds 339 to the INSTRUCT_PAIR_DEVICE of the service provider application 204b that the pairing is a success. The service provider 204 can access the services of the trusted application only after the authentication website 320 (executing on an access control server) pairs the user device 205 with the service provider 204.

### Protocol for Processing Instructions

FIG. 3C is a diagram of an example protocol (sequence) for processing an instruction in embodiments of the present invention. In FIG. 3c, the service provider 204 includes an encoder 210 configured in a secure environment on the platform (e.g., at an application server, web server, or such) of the service provider. In FIG. 3C, the user device 205 is used by service user 201 and includes an adapter and a TEE applet 208 configured at the TEE of the user device 205 (as described in reference to FIG. 2B). In some aspects, the encoder 210 is the counterpart service provider component to the device TEE applet 208. During a previous enrollment ceremony, the user device 205 registered with the service provider application 204a of the authentication website 204 (e.g., as shown in FIG. 3A). During a previous pairing ceremony (e.g., as shown in FIG. 3B), the authentication web site 206 (or registrar 221) paired the user device 205 to the service provider 204, which included preloading the user device 205 with the public keys of the service provider 204 and preloading the service provider 204 with the public keys of the user device 205. With a brokered trust in place through the pairing, the authentication website 206 can send instructions to the TEE applet 208 of the user device 205 that are only executed if signed by a paired service (e.g., service provider 204). In this way, the pairing allows the TEE applet 208 to validate the origin of the request, and if needed decrypt the contents of the instruction, prior to executing, displaying, and such Results of the execution are returned signed by the service provider key, assigned through the pairing, giving the service provider 204 confidence in the integrity of the execution.

In FIG. 3C, the service provider 204 prepares 380 an instruction or command (e.g., as part of a value transfer, such as a purchase) to the service user 201 of the user device 205. The instruction is formatted into an instruction record structure (e.g., C structure) acceptable for processing by the user device 205. The structure may contain the instruction type, the instruction code, version data, the user device identifier, instruction payload, and such. The service provider 204 passes the instruction to the encoder 210, which packages 381 the entire instruction structure for transmission to the user device 205 using functions from the encoder library. As part of packaging the instruction, the encoder 210 encrypts 382 the instruction using the preloaded public key of the user device 205, and signs 382 the instruction with the public key of the service provider 204. The encoder 210 may access the public key of the user device 205 from the authentication web site 206, directly from the block chain by locating the device registration record registered by the authentication website 206, or stored locally in secure memory of the service provider platform.

The service provider 204 then delivers (pushes) 334 the signed/encrypted instruction to the device adapter 214 by calling a device local command or API. The device adapter 214, in turn, passes 385 the instruction to the TEE applet 208 for processing. The TEE applet 208 decrypts 386 the instruction using the public key of the user device 205, and checks 386 the signature of the instruction against the public key of the service provider 204 preloaded at the user device TEE during the pairing ceremony, and any rules attached to the public key or in the access control list for the pairing. The TEE applet 208 then securely displays 387 the instruction to the service user 201 via a user device interface and, in response, receives secure input 388 from the service user 201 via the user device interface. Newer TEE environments support trusted display and input in addition to trusted execution. Trusted display enables a simple confirmation message, such as “confirm transaction amount,” to be presented to an end user. The TEE applet 208 then packages 389 the received input as a reply to the instruction and signs 390 the reply with the public key of the user device 205 (and may also encrypt the reply with the public key of the service provider 204). The TEE applet 208 transmits 391 the reply (response) to the adapter 214, which in turn, transmits 392 the response to the service provider 204.

The service provider 204 decodes and validates 343 the response using the public key of the service provider 204. The service provider 204 passes the response to the encoder 210 to check 394 the signature of the response against the public key of the user device 205. The encoder 210 may access the public key of the user device 205 from the authentication web site 206, directly from the block chain by locating the device registration record registered by the authentication website 206, or stored locally in secure memory of the service provider platform.

In other embodiments, the user device 205 may instead prepare, sign, and encrypt an instruction, which is sent to the service provider for execution. In these embodiments, the service provider 204 may verify the signature, decrypt, execute, and returns execution results (signed and decrypted) to the user device 205.

### Method of Enrolling and Verifying a Device

An embodiment may be a computer-implement method/system 400 of enrolling and verifying a user device in a block chain communication network (or other communication network). In some embodiments, the method/system may provide enrollment of the device as a service.

The method, at step 405, establishes a device identity for the user device in a communication network (e.g., block chain network) by generating a public/private key pair that is locked to the user device (e.g., within a TEE of the user device). The method (step) may also create a unique device identifier for the user device that is locked to the user device associated with the public/private key pair. In some example embodiments, the device user (operator) requests to perform transactions with a service (which may include installing an application associated with the service provide on the user device), and the server provider requests the user to generate the public/private key pair prior to engaging in such transactions. The service provider may further require the user device to enroll/register with an access control server (authentication website), including providing the generated public key to the access control server, prior to engaging in transactions. The enrollment/registration may include the user device installing a trusted application associated with the access control server or service provider at the user device (e.g., in the TEE of the user device).

In other example embodiments, the user device may contact the access control server prior to requesting transactions with the service provider, and the access control server may have the user device install a trusted application at the device TEE to generate the public/private key pair. In some embodiments, the registration with the access control server may be revoked by either setting a revocation flag or uninstalling the trusted application. The revocation of the registration may include deletion of the associated user device keys, and roll back to a previous state of the user device is prevented by enabling a one direction logging mechanism, which prevents the user device from accessing logs, measurements, access control lists, and such during previous states. In some example embodiments, the method (at step 405) may also create a user identity for authenticating the user, such as username, password, PIN, associate with a service for second factor verification, biometrics, and such.

In some embodiments, the user device signs the public key of the device's public/private key pair using an endorsement key established during: (i) manufacturing or creation of the device, (ii) manufacturing or creation of the execution environment of the device, and/or (iii) manufacturing or creation of an application on the device. The trusted application may generate a device registration record containing a device identifier generated by the trusted application, the registration date, the public key locked in the user device hardware, and an endorsement signature by the trusted application. The trusted application may record the device registration record in the block chain, or other secure memory communicatively coupled to the access control server. The service provider in which the user would like to perform transactions (or otherwise communicate) is also registered with the access control server. The access control server may also generate and record a registration record for the service provider.

The method, at step 410, records a device measurement record of the user device. The user device (e.g., by the trusted access control server application or other application executing at the user device, such as in the TEE) takes a series of measurements (e.g., health and integrity measurements) related to the user device, including measurements of the Platform Configuration Registers (PCRs), BIOS, OS, GPS, and such, which are formatted into a device measurement record. The device measurement records may further contain location, manufacturing company name, device make/model, and such of the user device. In some embodiments, prior to taking the measurements, the trusted application or other application communicatively coupled to the user device may perform tests on the user device to determine that the user device is in a good condition or state (e.g., compare against known manufacturing configurations and data, run virus scans, and such). In some embodiments, the user device takes the measurements when the user device powers on and when a change is detected in an environment of the user device

The trusted application executing in the TEE of the user device endorses (e.g., as a service) the device measurement record. The trusted application calculates a hash value for the endorsed device measurement record and signs the endorsed device measurement record using the public key or the private key of the user device depending on the embodiment. The trusted application (or another third-party service communicatively coupled to the user device) records the signed hash value in the block chain, other public cryptographic ledger (e.g., Namecoin), or other secure global memory communicatively coupled to the user device and/or access control server. The recorded signed hash value represents a reference value indicating a known good condition or state of the user device.

The method, at step 415, pairs the service provider to the user device. As part of enabling transactions between the service provider and user device, the trusted application executing in the device TEE, generates a pairing between the service provider and user device. In generating the pairing, the trusted application may generate a pairing registration record, including a unique device identifier for the pairing, the public key of the user device, and the public key of the service provider. The trusted application may record the pairing registration record in the block chain or other secure memory communicatively coupled to the trusted application. The trusted application also provides the public key of the user device to the service provider, and the public key of the service provider to the user device, which is locked in the TEE of the user device. In some example embodiments, as part of the pairing, the service provider may install a service provider application (in communication with the trusted application) at the user device (e.g., in the TEE) for facilitating transactions with the service provider.

The trusted application (or service provider application in communication with the trusted application) may generate an access control list (also referred to as a trusted execution list), where controls related to the execution of a instruction within the pairing can be configured, referenced, and updated. The public keys of the user device and service provider may be stored in an access control list, and particular controls associated with a particular key. The access control list may have default control rules that must be satisfied prior to executing an instructions communication within the pairing. The access control list may also be updated by the trusted application to indicate control rules and conditions in relation to a particular instruction (e.g., as requested by the service provider or user device), and to record data related to a current instruction of the pairing. The access control list may, for example, indicate the authorized period of time for executing an instruction, an effective date when the instruction is allowed to be executed by the trusted application, an expiration date when the instruction is no longer allowed to be executed by the trusted application, maintain count on the number of executed instructions, whether an instruction is within a limit on the number of executions, and whether the instruction is associated with an external condition (factor) that must be verified prior to execution of the instruction. The access control list may be associated with an external timestamp that may provide evidentiary proof of state of the access control list.

In some embodiments, the current state of an access control list is integrated into the device health and integrity measurement, and dynamic data of the access control list capable of modifying the device health and integrity measurement is excluded from the health and integrity measurement. The trusted application may also maintain log data on whether a received instruction is executed, the number of times an instruction is executed within a pairing, functions associated with the instruction, and reasons for an instruction failing to be executed by the user device, and such. The trusted application may then record and update the access control list and log hashed in the block chain, or other secure memory communicatively coupled to the trusted application, to provide evidentiary proof of state of the access control list. Further, in some example embodiments, at least a portion of the access control list is backed up in memory communicatively coupled to the user device and access control server, and the backed-up access control list is recoverable. Certain secure elements of the access control list excluded from the backed-up access control list.

The method, at step 420, initiates an instruction by the service provider as part of a transaction with the user device. The service provider prepares the instructions and formats the instruction into an instruction record structure (e.g., C structure) acceptable for processing by the user device. The structure may contain the instruction type, the instruction code, version data, the user device identifier, instruction payload, and such. The service provider may include an encoder which packages the instruction structure for transmission to the user device. As part of packaging the instruction, the encoder may encrypt the instruction using the public key of the user device, and signs the instruction with the public key of the service provider. The service providers transmit the signed (possibly encrypted) instruction to the user device (trusted application).

The method, at step 425, verifies that the user device is allowed to execute the instruction. In some embodiments, prior to the trusted application or service provider application processing the instruction, the trusted application (or other third-party application) must generate a current device measurement record on the health and integrity of the device that is compared to the reference hash value recorded for the user device. The device measurement record is calculated using the same measurements as the reference value on the current state or condition of the user device, and compared against the recorded reference hash value. In some embodiments, the access control list provides an entry for generating and comparing the current device measurement record. In some embodiments, the trusted application must provide the current device measurement to the service provider, which verifies the current device measurement against the reference value stored in the block chain or such, prior to sending the instruction to the user device or prior to approving execution of the instruction at the user device. In some embodiments, the trusted application signs instruction results returned to the service provider with a hash of the device measurement record, which the service provider may verification against the recorded reference value prior to processing the instruction results. In some embodiments, confirmation by the device operator (end user) is required to prior to the trusted application sending the device measurement record from the user device.

Prior to the trusted application or service provider application processing the instruction, the trusted application may also perform actions and check internal and external conditions (rules) for the instruction as indicated in the access control list, which may be stored in the access control list or other format attached to the service provider and user device keys. For example, the trusted application may confirm that the instruction is being processed before a specified expiration time (i.e., not older than a specified time window) of the instruction and that the instructions and that the instruction does not exceed a count of instructions allowed for the pairing. In some embodiments, the trusted application may secure completion the external condition by the use of a public key infrastructure (PKI) challenge response that may be returned to the service provider. The trusted application may also log data related to the instruction in the access control list (e.g., instruction count, matching health/integrity measurement, PKI challenge response, and the like) or other maintained log, which may be updated at the block chain or such.

If the instruction is verified for processing, the method, at step 430, processes/executes the instruction at the user device. Prior to processing, the trusted application may sign the instruction with the hash of the current measurements (which has a multi-signature of the measurements and service provider public key) and record the instruction in the block chain or other secure memory. In processing the method, the trusted application or service provider application may decrypt the instruction using the user device public key and confirm the signature of the instruction against the service provider public key. The trusted application or service provider application may then execute the instruction to generate instruction results, or display the instruction to the device operator for input, or such. The trusted application or service provider application may then encrypt the execution results, operator input, or such with the key of the service provider (in some embodiments) and then sign with the key of the user device. The trusted application or service provider application may also sign the execution results, operator input, or such with the hash of the current device measurement.

The trusted application or service provider application sends the signed execution results, operator input, or such as a message to the service provider. The service provider, using the encoder, may check the current device measurement hash of the message against the reference hash recorded on the block chain, decrypt the message (if encrypted) using the service provider key, and check the signature of the message against the user device key. If all signatures match, then service provider may process the execution results, user input, and such to complete or continue the transaction with the user device. The service provider may also record the message at the block chain or other secure memory.

### Securing Transactions Using Device Authentication

Embodiments of the present invention execute service provider applications in a secure execution environment on a user device. The secure execution environment also execute code that generates and stores device keys (e.g., public and private key pairings) applied in transactions using the service provider applications in this secure execution environment. The secure execution environment allows authentication by the user device, rather than, or in addition to, authentication by a service provider end user.

Unlike mobile telephony or cable television, for example, where a service is customarily authenticated by an enabling device of the service, the web instead customarily requires that end-users of the enabling device conduct authentication, such as enter a username and password. In circumstances, portability in the form of username/password has a role to play. While there are benefits to the portability of end-user authentication, this authentication method is dangerously susceptible to issues in practice. For example, users are terrible at remembering complex passwords and irritated by repetitive requests. As a result, users create passwords like “GoYanks” and allow web session keys to persist for days.

The improved method of second factor authentication, which is well established though in limited use, does not address these issues with end-user authentication. Second factor authentication is perhaps utilized most prominently by Bitcoin services, where breaching a login can provide immediate and irreversible theft of funds. Second factor authentication is commonly implemented in the form of a Short Message Service (SMS) confirmation or key fob. Second factor authentication requires an end user logging into a service provider to enter a username and password, and then enter a code messaged (e.g., via SMS) to the registered phone of the end user, or provided via the key fob, by the service provider. Second factor authentication is an improved step for login security; however, second factor authentication burdens the user with additional requirements. End users' resistance to second factor authentication is evidenced by the fact that when a service allows end users to opt out of such repeated confirmations, many users readily select to opt out (choosing time saving degradation of security).

Embodiments of the present invention provides authentication by the device of the end user, rather than (or addition to) authentication by the end user. A device, unlike an end user, can engage without irritation in a cryptographic authentication well beyond the capacity of any human end-user authentication and using any of thousands of credentials that can be stored in the device's hardware. The device can also engage in the cryptographic authentication over and over without fatigue. Further, such device authentication can be transparent to the user (or further secured with a PIN) and provides a level of assurance that enables bypassing hassling the end user for identity and authentication credentials. Moreover, most of the time end users engage with the same devices they own for the same interactions. By leveraging these devices to conduct authentication, user interaction consistency can be rewarded with immediate access for users and increased assurance for service providers.

In addition, a device (machine) generated cryptographic authentication (proof) tends to be far more reliable than a username and password, both of which are probably based on memorable facts attributed to the user. The end user is best relegated to the job of simply protecting the device that performs the authentication, as ten thousand years of evolution has trained people to protect such valuable objects. That is, although people are so trained to protect value objects (e.g., devices), people find it hard to remember even a ten digit phone number. Devices, on the other hand, are purposely-built for reliably fast computations. In some embodiments, if the end user is without the end user's regularly used device, the service can still resort, via the service provider application, to requesting user authentication. Further, in an atypical situation, such as being without a regularly used device, an end user is often more acceptable to a more onerous authentication (e.g., enter username/password).

There are a number of widespread tools used in different embodiments of the present invention to facilitate authentication by a device of an end user. These tools ranges from hardware backed device identity to full trusted execution environments.

A trusted execution environment or TEE is a tool configured on the user device to execute applications (e.g., service provider application). The installation and execution of applications (apps) on the user device is meant to be very simple. However, there is a class of apps that can benefit greatly from strong assurance of their origin and opaque separation from the execution of other apps, as provided by a TEE. Unlike an app running on the primary OS (Rich OS) and memory stack of the user device, an app running in the TEE of the user device has access to cryptographic primitives that enable the app to be executed without snooping by the OS. In ideal circumstances, the app executing in the TEE also has direct access to user input and display to ensure a private interaction with the operator of the user device.

Both proprietary and standards based solutions in support of a trusted execution environment for a user device have worked their way into the supply chain, and may be used in embodiments of the present invention. The Trusted Platform Module, or TPM, for instance, is a security chip embedded on the motherboard of most modern PCs. The TPM technology is specified by the Trusted Computing Group (TCG), a non-profit consortium of dozens of major vendors. The TPM technology was designed largely in support of enterprise network security, but has played a huge role to play in simplifying the consumer web. TPM's have been used in enterprise security for approximately half a dozen years and are now widely prevalent in modern PCs. Microsoft logo compliance beginning in 2015 may be ensured by delivering all devices with a TPM.

A further example method, may be to first validate with the device from which the authentication request is sent. Using a TPM or any other secure source of cryptographic key sets, a web service can ask the device to prove it is the same device it was before.

A TPM is a relatively simple technology that serves three basic purposes: PKI, BIOS integrity, and encryption. While the TPM technology has been pursued for well over a decade, only recently have devices configured with TEE have become available. For example, Intel began delivery of commercial solutions in 2011 and Trustonic launched a commercial solution in 2013. The TPM platforms and associated tools are now reaching the level of maturity required for consumer use (in consumer devices). Deploying an app into the TEE of a device is akin to delivering a dedicated hardware device, as execution and data in the TEE are cryptographically isolated from any other functions of the device in the primary OS.

The TPM secure chip has no identity of its own, but can be configured to generate the key pairs (public and private keys) of example embodiments of the present invention. In example embodiments, these key pairs, also referred to as attestation identity keys (AIKs), can be marked as “non-migratable” so that the private half of the key pair will never be visible outside the hardware (TEE environment). This provides an opportunity to establish a device (machine) identity that cannot be cloned by other device or applications. Currently deployed TPMs (version 1.2) are limited to RSA and SHA-1, while TPM (version 2.0) are more agile.

A TPM implements an Endorsement Key (EK). The EK is installed during manufacture and can be used to prove that the TPM is in a fact a real TPM. A device configured with a TPM loads Platform Configuration Registers (PCRs) during its boot sequence. During the boot sequence, beginning with the firmware of the device, each component in the boot process measures its state and the state of the next process, and records a PCR value for the measurement. As the PCRs are captured in the tamperproof TPM of the device, a reliable quote or measurement of the system's BIOS integrity can subsequently be requested. A PCR does not capture what actually happens to the device components during execution, but only captures, through a series of hashes, that the state of these components have not changed over time. These captured hashes are particularly important for protection against the most serious and otherwise undetectable attacks, where a hacker compromises the device Bios or installs a secret hypervisor. Combined with an assurance signature from virus scanning software, a the device or system controlling access to the device (e.g., access control system or authentication server) can establish a reliable state of health of the device.

TPMs may also provide bulk encryption services in example embodiments of the present invention. In example embodiments, encryption keys may be generated by the device in the TPM, but the encryption keys not stored in the TPM. Instead the keys are encrypted with a TPM bound Storage Root Key and returned to the requesting process (e.g., executing at the service provider, access control server, or the device) for storage. When the process needs to encrypt or decrypt data, the process first retrieves and mounts the stored encryption key. The process then decrypts the encryption key in the hardware executing the process, and makes the key available for ciphering. As with most TPM keys, the encryption keys can be further protected with a password if desired.

Trustonic provides a trusted execution environment across a broad array of smart devices, which may be used in example embodiments of the present invention. Trustonic (http://www.trustonic.com) is a joint venture of ARM, G+D and Gemalto. The goal of Trustonic is to enable the secure execution of sensitive application services. Trustonic is an implementation of the Global Platform standard for Trusted Execution Environments. Apps configured and loaded for execution in the Trustonic TEE are signed and measured. Devices supporting Trustonic provide an isolated execution kernel, so that a loaded app on these devices cannot be spied on by any other process running on the devices, including debug operations on a rooted device. Trustonic was formed in 2012 and now ships to approximately half a dozen device manufactures and supports a dozens of service providers. Over 200 million devices are now shipped with Trustonic support.

Intel vPro also provides a trusted execution environment, which may be used in example embodiments of the present invention. Intel vPro is collection of technologies built into modern Intel chip set. New devices/machines marketed with vPro support the Intel TXT Trusted Execution technology. Intel vPro offers a secure processing environment in the management engine (ME) of a device that enables protected execution of numerous cryptographic functions. The Intel vPro capabilities included in the deployment of TPM 2.0 functionality implemented as an app in the ME. The ME also supports secure display functions for conducting fully isolated communications with the user of the device. In this manner an app executing in the ME can be controlled by the user with a substantially reduced risk of compromise.

ARM TrustZone also provides a trusted execution environment, which may be used in example embodiments of the present invention. ARM TrustZone provides the silicon foundations (primitives) that are available on all ARM processors. These primitives isolate a secured world of execution from the common execution space of a device. ARM provides the designs that are then built into a number of standard processors. To use the TrustZone primitives, apps can either be deployed at the device as part of system firmware by the manufacturer or can be delivered after the fact through third party tools like Trustonic, Linaro or Nvidia's open source micro kernel.

Some embodiments of the present invention apply such trusted execution technologies (e.g., Trustonic, Intel vPro, TrustZone) into a set of services for enhancing the transaction environment that connects people and the block chain.

### Birth Certificate for the Device

Embodiments of the present invention attest to device health and integrity prior to engaging in electronic transactions.

Block chain transactions do not have verification or cyber security controls on an unknown device performing the transactions. Therefore, embodiments provide a full validation of an unknown client device prior to acceptance of a block chain transaction or other service transaction to achieve further security for block chain transactions. Example embodiments use the principles of the Trusted Network Connect (TNC) standards under which the integrity of a device may be verified prior to actual enablement of the connection to a network switch. Before connecting a device to a network switch for the first time (when the device is known to be in a good condition or state), the device performs a series of measurements on the state of the device, which are calculated into a hash. The measurements typically would include validation of the BIOS image of the device, the operating system (OS) of the device, and any applications on the device that could be altered. The device or an access control server in communication with the device may securely record the measurement hash as a reference hash value on the block chain or other secure memory communicatively coupled to the device or access control server. Before further connections to the network, the device would perform the same series of measurements on the current state of the device, which are also calculated into a hash. Upon connection to the network, the network switch checks if the current hash value matches the stored reference hash value to determine if the device is in a known good condition or state. As such, the network switch checks the current health and integrity of the device. The Trusted Execution Environment (TEE) is also capable of self-measurement processes and remote attestation of the health and integrity of the device. In some preferred embodiments, the TNC system is based on the Trusted Computing Group (TCG) standards and typically the Trusted Platform Module (TPM) chip is integrated.

During a block chain transaction or other service provider transaction with the device, the device, with or without user input, creates or executes an instruction within the measured execution environment of the device (e.g., TEE). The device would sign the instruction using the public key of the device (referred to as the verification signature). The device also performs the series of measurements on the current state of the device, calculate a hash on the measurements, and sign the instruction using the hash (referred to as the integrity signature) The device, or access control server in communication with the device, sends the signed instruction to the block chain network for processing. The block chain network requires the multiple signatures to accept the transaction. The block chain network verifies the verification signature based on the public key stored for the user in the block chain. The block chain network then verifies the integrity signature of the execution environment by comparing the integrity signature to the reference has value previously recorded on block chain indicating the known good condition or state of the device. If the signature matches the reference hash value the instruction is allowed to proceed (be executed or transmitted as part of the transaction).

If the integrity signature and reference hash value do not match then the system will require a third out of band process to be completed to verify that the transaction is allowed to proceed even though the execution environment is not in a known good condition. Because, the transaction may not have any verification or cyber security controls on an unknown device performing a transaction, embodiments may require a full validation of an unknown device being in a known good condition. This full validation may comprise a third party's statement that the device is configured correctly prior to the acceptance of a transaction. Some embodiments of the present invention, therefore, can address a broad range of cyber security controls that should be required as part of any block chain transaction processing system.

The validation of device health and integrity in a block chain or other transaction is further described in U.S. patent application Ser. No. 15/074,784, filed Mar. 18, 2016, U.S. Provisional Application No. 62/136,340, filed on Mar. 20, 2015, and U.S. Provisional Application No. 62/136,385, filed on Mar. 20, 2015, which are herein incorporated by reference in their entirety.

### Using Transactions on the Block Chain to Accumulate Ownership Rights

A wallet is a component of the account of a bitcoin user that functions similarly to a bank account. The bitcoin wallet can be used to receive and store bitcoins for a user, as well as transfer bitcoins to one or more other users in the form of electronic transactions in the bitcoin block chain communication network. A bitcoin address is a unique identifier associated with a bitcoin wallet, and allows the transfer (sending/receiving) and storage of bitcoins. The transactions in the bitcoin block chain communication network are usually free; however, transactions that send and receive bitcoins using a large number of bitcoin addresses will usually incur a transaction fee. The bitcoin wallet coupled to a user's bitcoin account also stores the private keys of the user, so that the user can access bitcoin block chain records associated with the bitcoin walled.

In embodiments of the present invention, a transaction on the block chain network may accumulate or achieve an ownership right in a service. For example, a user purchases, through an online service provider, a given number of download of a video may achieve a new ownership (e.g., license for free replay) right in the downloaded video. A bitcoin application (via a transaction interrogation process implemented as a part of executing the electronic transaction) may be provided whereby bitcoin transactions associated with a bitcoin wallet address accumulates the ownership right. Some embodiments may confirm the health and integrity of the user device being used to facilitate the electronic transactions prior to the bitcoin application or smart contracts engaging in the transactions to accumulate the ownership right.

In some embodiments, the bitcoin application logs bitcoin transactions associated with a bitcoin wallet address in a transaction record associate with the bitcoin account. The bitcoin application identifies in the log a chain of bitcoin transactions between the bitcoin wallet address and a service provider. In some embodiments, the bitcoin application/transaction record comprises a smart contract associated with the bitcoin block chain that includes the attribute information identifying each transaction in the bitcoin transaction record. In other embodiments, the transaction record may be an access control list generated based on a pairing between the user device and the service provider, as describe with reference to FIG. 4. In these embodiments, the access control list includes the attribute information identifying each transaction.

In some embodiments, the transactions in the transaction record associated with the bitcoin wallet address may form a chain with cryptographic assurance. The smart contract or bitcoin application (via the transaction interrogation process) allows a user to query the last transaction recorded in the transaction record associated with the bitcoin account. The smart contract or bitcoin application calculates a level of expenditure for a specific item (or items) based on cryptographic assurance of the formed chain.

The transaction interrogation process by the smart contract or bitcoin application in the bitcoin block chain network monitors the transaction record. Every time a specific item is purchased from the service provider (or in some embodiments a list of service providers) in a small (micro) transaction associated with the bitcoin wallet address, the smart contract may incorporate (apply) the attribute data of the last transaction as part of the attribute data of the current transaction. Similarly, in other embodiments, the bitcoin application on or communicatively coupled with the device of the bitcoin user may incorporate (apply) the attribute data of the last transaction as part of the attribute data of the current transaction in an access control list. In some embodiments, the smart contract or bitcoin application, checks the transaction record for the existence of a previous associated transaction. Based on the existence of the previous transaction, the smart contract/bitcoin application obtains an accumulated value (e.g., attribute information) attached to the previous transaction. The smart contract/bitcoin application increments the obtained accumulated value and attaches the incremented accumulated value to the current transaction in the transaction record. The smart contract/bitcoin application applies the incremented accumulated value to the current transaction. In other embodiments, the smart contract or bitcoin application may accumulate transactions in any manner known in the art without limitation.

In some embodiments, applying the accumulated value to the previous transaction may include the smart contract or bitcoin application associating an achievable ownership right with a cryptographic key and storing the key in a tamper resistant storage. The smart contract or bitcoin application then obtains a set of transactions contributing to the accumulated value associated with the achievable ownership right, and verifies the set of transactions prior to applying the accumulated value to the current transaction.

A specific item or list of specific items of the service provider qualifying for the accumulation of transactions may be specified in the smart contract or access control list. Incorporating the last transaction to the attribute data in this manner assures that the accumulation of transactions is quickly and efficiently verified by reading the information on the block chain. In this way, the smart contract or bitcoin application can easily accumulate many small transactions associated with a bitcoin wallet address and service provider in the smart contract or an access control list in a secure memory local or remote from the device of the bitcoin user.

Once the smart contract or bitcoin application (via the transaction interrogation process) determines that specific level (e.g., number of transactions, amount of transactions, and such) of transactions is reached, the smart contract or bitcoin application stops accumulation of transactions in the attribute data and determines a persistent ownership right or replay right associated with the bitcoin wallet address. The smart contract or bitcoin application records the persistent ownership/replay right to the bitcoin block chain bound to the bitcoin wallet address of the user. In other embodiments, the smart contract or bitcoin application create a new transaction record associated with the bitcoin account; and stores an indication of the achieved persistent ownership/replay right in the newly created transaction record.

In other embodiments, the smart contract/bitcoin application (via the transaction interrogation process) sets a plurality of charges incurred for executing the electronic transaction to zero. The smart contract/bitcoin application then determines the achievement of a persistent ownership right associated with the bitcoin account based on the incremented accumulated value reaching or exceeding a predetermined maximum accumulated transaction value.

In some example embodiments, the set of transactions to accumulate the ownership right must be completed within a specific period of time in order to contribute to the achievement of the ownership right. In some example embodiments, the achieved ownership right may expire after a specific period of time and/or expires based on the lack of use of the ownership right. In some example embodiments, the achieved ownership right is used as part of a multiple signature transaction to enable the purchase of additional transactions requiring an indication of the achieved ownership right. In some example embodiments, the transaction is associated with a single item and involves two achieved ownership rights (e.g., associated with the same or different bitcoin account), and the accumulated values associated with the ownership right are cryptographically merged to result in a single accumulated value toward the ownership right.

The describes embodiments of accumulating ownership rights specifically reference the bitcoin protocol, but may also be implemented in any other block chain related protocol without limitation.

### Assured Computer Instructions to Cloud Services and Peer Services

The current state of computing is based on an authentication model in which devices connect to a cloud service (like Twitter) and then assume that the follow-on data exchanged over the connection is correct. In the current state, encrypted transport is commonly used and the authentication model is based on authentication (assuring) the entire complex device/computer that sends/receives the data to/from the cloud service. Technologies like anti-virus and integrity validation are provided for authenticating (assuring) the condition of the device/computer. Once authenticated, an assumption is then made that the entire complex device/computer is in a safe condition and that the critical data delivered from the device/computer can be trusted.

In a general purpose computing device, authentication is typically used to connect to critical services. However, even with strong authentication, there is no assurance that the information sent to the cloud service is the information the user intends. Malware can find many ways to alter the data and result in the theft or compromise of sensitive data. Embodiments collect a number of sources of both local and remote data to assure that the information provided to the cloud service is the data that is intended. In embodiments, certain data may be locally unmasked at the cloud service to assure a process has been completed but the detailed private information remains masked. The cloud services may the used the unmasked data to verify the transactions are intended and incorporate a number of additional process steps internally and externally that are controlled by the user. These steps can assure logging and additional verification to assure the transaction is correct. Embodiments may be used in financial systems, to control the internet of things from door locks to medical devices, and such.

In some embodiments of the present invention, the current authentication of a device connected to a cloud service (or other web-based service) is augmented with secure (assured) computer instructions. The secure instructions are formed within the local environment of the device for delivery to a computer of the cloud service to assure these instructions are correct. For example, the instructions may be formed in a trusted execution environment (TEE) of the device by a trusted application. The trusted application may collect and append verification information, such as time, location, identity, compliance or other critical data locally or remotely, and such to the secure instruction, and provide the user a mechanism to securely confirm the instruction is part of an intended transaction prior to the instruction being signed and sent. A trusted application (on or communicatively coupled to the device) may collect the verification information from user input, local device input and state, remote system input and state, and such. The authentication may also include local or remote approvals prior to the secured instruction being released. The device then delivers these secure instructions to remote cloud services for processing.

In some systems, local data related to the secure instruction is tokenized in the attached verification information to protect privacy. For example, the phone number of the device user may be used to indicate that the device user is a specific cloud service provider's customer and in good standing. However, the only verification information that is passed on attached to the instruction is the good standing status (not the user's name or phone number). The tokenization may be performed by contacting the cloud service provider locally using the phone number and instead configuring the confirmation data to include a provider transaction identity associated locally to the phone number that can be remotely verified by the cloud service provider.

The cloud service receives the secured instruction and verifies (via a verifying device of the cloud service platform) that the secure instructions (and other elements of the transaction) are accurate prior to the instructions being accepted for processing the secure instructions. The verification process executed by the verifying device may impose local or remote policies that verify local and remote date of the attached verification information of an instruction prior to accepting the instruction for processing. The verification process may include user verification, confirmation or checking signatures from logging systems, verifying location, time, and such of the secured instruction, and other critical process steps. The verification process may also assure that the transaction came from a known source that meets the minimum number of parameters.

The verifying device may be configured with a logic script that is cryptographically assured to provide the local and remove policies required for verifying instructions of a specific transaction. The script validation may be included as part of the attached verification information of an instruction configured by the sending device. The cloud service may receive the instruction as real time data that is locally assured by the cloud service and then modified by the cloud service so the instruction is a delta to a real time state, for example, to increase speed of a pump.

In some embodiments, the cloud service may leverage the local data of the attached verification information to assure the isolated execution environment of the sending device is in a proven known condition at the time of sending the secured instruction. The cloud service may also log the resulting data from the instruction, such as in a block chain or other secure memory.

The teachings of all patents, published applications and references cited herein are incorporated by reference in their entirety.

While this invention has been particularly shown and described with references to example embodiments thereof, it will be understood by those skilled in the art that various changes in form and details may be made therein without departing from the scope of the invention encompassed by the appended claims.

1. A computer-implemented method of controlling access between a computing device with a service provider, the method comprising:
executing a trusted application in an environment on a computing device in isolation from the primary operating system (OS) of the computing device;
generating a unique device key for the computing device within the executed trusted application;
registering the generated unique device key for the computing device with an access control application; and
pairing, by the access control application, the computing device with a service provider registered with the access control service, the pairing including the access control service sending: (i) the unique device key to the service provider and (ii) a unique service key of the service provider to the computing device.

2. The method of claim 1, further comprising:
signing, by the service provider, an instruction using the unique service key, and sending the signed instruction to the computing device;
verifying, by the trusted application, the signature of the instruction matches the unique service key;
if the instruction signature is verified, executing the instruction within the trusted application to generate instruction results, wherein recording the executed instruction on the block chain;
signing, by the trusted application, the instruction results using the unique device key, and sending the signed instruction results to the service provider;
verifying, by service provider, the signature of the instruction results matches the unique device key; and
if instruction results signature is verified, recording the instruction results on the block chain.

3. The method of claim 2, further comprising:
encrypting, by the service provider, the instruction using the unique device key, and sending the signed instruction to the computing device; and
decrypting, by the trusted application, the signed instruction using the unique device key prior to executing the instruction within the trusted application.

4. The method of claim 2, wherein instructions received at the computing device from the service provider are accumulated in memory local to the computing device, the accumulated instructions being recorded on the block chain once the accumulated instructions meet a threshold condition.

5. The method of claim 2, wherein maintaining an access control list for the pairing that includes at least one of: the unique device key, the unique service key, an effective date when the instruction is allowed to be executed by the trusted application, an expiration date when the instruction is no longer allowed to be executed by the trusted application, whether the instruction is within a limit on a set number of executions, and whether the instruction is within an external condition requiring positive verification prior to execution of the instruction.

6. The method of claim 5, wherein at least one of:
verifying the instruction against the access control list prior to executing the instruction;
assuring completion of verification against the access control list by an access control application using a PKI challenge response;
providing evidentiary proof of state of the access control list by associating an external time stamp or an external block chain registration event with the access control list;
backing up at least a portion of the access control list, the backed-up access control list being recoverable, wherein certain secure elements of the access control list are excluded from the backed-up access control list;
maintaining one or more logs associated with the access control list containing at least one of: number of times a given instruction is executed and specific functions of the given instruction; and
deleting the access control requirements includes: deleting the generated unique device key and the service key, and preventing roll back of the device to a previous state by enabling a one direction logging mechanism.

7-12. (canceled)

13. The method of claim 2, further comprising:
measuring current health and integrity of the computing device;
verifying the current measured health and integrity against a stored reference value of the measured health and integrity of the computing device in a known good state; and
sending the signed instruction to the computing device, only if the current measured health and integrity of the computing device is verified.

14. The method of claim 13, wherein at least one of:
the reference value is measured and stored when the computing device powers on and when a change is detected in an environment of the computing device;
the measured health and integrity includes one or more of: platform configuration registers (PCRs) generated by the boot process, BIOS Version, OS Version, GPS location, manufacturing company name, device make, and device model;
current state of an access control list is integrated into the device health and integrity measurement, and dynamic data capable of modifying the device health and integrity measurement is excluded from the health and integrity measurement
one or more of: (i) signing the instruction by both the unique device key and a hash of the current measured health and integrity and (ii) signing the instruction results by both the unique service provider key and a hash of the current measured health and integrity; and
the verification of the current measured health and integrity is performed by a third-party application.

15-19. (canceled)

20. The method of claim 1, wherein the trusted application can be revoked from the user device by either setting a revocation flag or removing the trusted application.

21. The method of claim 1, wherein at least one of:
multiple computer devices operated by the user of the computing device are grouped into a single entity and one unique device key is generated for the group; and
the unique device key and the unique service key are each a public key of a digital cryptographic public and private key pair.

22-23. (canceled)

24. A computer system for controlling access between a computing device with a service provider, the method comprising:
a trusted application executing in an environment on a computing device in isolation from the primary operating system (OS) of the computing device, the trusted application configured to:
generate a unique device key for the computing device within the executed trusted application;
register the generated unique device key for the computing device with an access control application; and
the access control application executing in an environment communicatively coupled to the computing device, the access control application configured to:
pair the computing device with a service provider registered with the access control service, the pairing including the access control service sending: (i) the unique device key to the service provider and (ii) a unique service key of the service provider to the computing device.

25. The computer system of claim 24, further comprising:
an encoder configured on a server in the environment of the service provider, the encoder configured to:
sign an instruction using the unique service key, and send the signed instruction to the computing device;
the trusted application, in communication with a service provider application configured on the computer device, further configured to:
verify the signature of the instruction matches the unique service key;
if the instruction signature is verified, execute the instruction within the environment of the computing device to generate instruction results, the executed instruction being recorded the executed instruction on the block chain;
sign the instruction results using the unique device key, and sending the signed instruction results to the service provider;
the encoder further configured to:
verify the signature of the instruction results matches the unique device key; and
if instruction results signature is verified, record the instruction results on the block chain.

26. The system of claim 25, wherein:
the encoder is further configured to:
encrypt the instruction using the unique device key, and sending the signed instruction to the computing device; and
the trusted application is further configured to:
decrypt the signed instruction using the unique device key prior to executing the instruction within the trusted application; and
the unique device key and the unique service key are each a public key of a digital cryptographic public and private key pair.

27. The system of claim 25, wherein instructions received at the computing device from the service provider application are accumulated in memory local to the computing device, the accumulated instructions being recorded on the block chain once the accumulated instructions meet a threshold condition.

28. The system of claim 25, wherein the access control application is further configured to maintain an access control list for the pairing that includes at least one of: the unique device key, the unique service key, an effective date when the instruction is allowed to be executed by the trusted application, an expiration date when the instruction is no longer allowed to be executed by the trusted application, whether the instruction is within a limit on a set number of executions, and whether the instruction is within an external condition requiring positive verification prior to execution of the instruction.

29. The system of claim 28, wherein the access control application is further configured to at least one of:
verify the instruction against the access control list prior to allowing the trusted application to execute the instruction;
assure completion of verification against the access control list by access control application using a PKI challenge response;
provide evidentiary proof of state of the access control list by associating an external time stamp or an external block chain registration event with the access control list;
backup at least a portion of the access control list, the backed-up access control list being recoverable, wherein certain secure elements of the access control list are excluded from the backed-up access control list;
maintain one or more logs associated with the access control list containing at least one of: number of times a given instruction is executed and specific functions of the given instruction; and
delete the access control requirements, including: deleting the generated unique device key and the service key, and preventing roll back of the device to a previous state by enabling a one direction logging mechanism.

30-35. (canceled)

36. The system of claim 25, wherein:
the trusted application is further configured to measure current health and integrity of the computing device;
the control access application is further configured to: verify the current measured health and integrity against a stored reference value of the measured health and integrity of the computing device in a known good state; and
the encoder is further configured to send the signed instruction to the computing device, only if the current measured health and integrity of the computing device is verified.

37. The system of claim 36, wherein at least one of:
the reference value is measured and stored by the trusted application when the computing device powers on and when a change is detected in an environment of the computing device;
the measured health and integrity includes one or more of: platform configuration registers (PCRs) generated by the boot process, BIOS Version, OS Version, GPS location, manufacturing company name, device make, and device model;
current state of an access control list is integrated into the device health and integrity measurement, and dynamic data capable of modifying the device health and integrity measurement is excluded from the health and integrity measurement; and
one or more of: (i) the encoder signs the instruction by both the unique device key and a hash of the current measured health and integrity and (ii) the trusted application signs the instruction results by both the unique service provider key and a hash of the current measured health and integrity.

38-43. (canceled)

44. The system of claim 24, wherein a ring manager groups multiple computer devices operated by the user of the computing device into a single entity and generates the unique device key for the group.

45-46. (canceled)

47. The system of claim 24, wherein at least one of the instruction or instruction results are:
attached with local and remote verification information related to the environment of the computing device, and the service provider applies rule-based policies to the verification information to confirm condition of the computing device prior to executing an instruction or instruction results received from the computing device, or
attached with local and remote verification information related to the environment of a sending device of the service provider, and the trusted application applies rule-based policies to the verification information to confirm condition of the service provider device prior to executing an instruction or instruction results received from the service provider.

48-53. (canceled)
